(19) United States
(12) Patent Application Publication
(10) Pub. No.: US 2008/0235061 A1
(43) Pub. Date: Sep. 25, 2008

(54) Arrangements For Deriving Financial Benefits From Equity Owned in Property

(76) Inventor: Ian Rossel Caple Innes, New South Wales (AU)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/592,020

(22) PCT Filed: Aug. 24, 2005
(86) PCT No.: PCT/AU05/01274

§ 371 Date: Sep. 7, 2006

(30) Foreign Application Priority Data
Aug. 24, 2004 (AU) 2004904830
Oct. 26, 2004 (AU) 2004906176
Dec. 31, 2004 (AU) 2004607385
Jul. 8, 2005 (AU) 2005903656

(51) Int. Cl. G06Q 40/00; G06Q 20/00; G06F 17/10

(52) U.S. Cl. 705/4; 705/40; 705/36 R; 705/35

(57) ABSTRACT

A system and method for providing equity based benefits to a person dependent upon equity in property owned by the person is disclosed. The method (2200) is implemented on a computer based system (600) and comprises securing (810, 210) a loan secured by a proportion of the equity, the loan having a principal value for a defined term, repaying (816, 216) the loan by periodically paying a simple interest charge being a fixed proportion of the principal, investing (811, 211) a residual of the loan, if an equity-based retirement savings option is elected accumulating (824) earnings from the invested residual of the loan, and if a life-expectancy retirement annuity option is elected, making (213) a periodic payment from the residual of the loan; wherein the principal value of the loan becomes due for repayment at the end of the term.

### FIELD OF THE INVENTION

The present invention relates generally to saving arrangements and retirement benefit arrangements, and in particular, to arrangements that build upon the equity in a persons wholly or partially owned home.

### BACKGROUND

People who approach or reach retirement age often have invested, through the course of their working lives, in their home. Such people thus often have fully or largely paid up homes when they reach retirement, but may have insufficient income upon which to live. Financial products such as reverse mortgages are available, enabling the retiree to “convert” some of the value of their home into income. However, such existing products can be expensive and inconvenient.

People who attain middle age often have invested, through the course of their working lives, in their home. Such people thus often have fully or largely paid up homes while they are still ten to fifteen years away from retirement. The equity which they have in their home may provide them with a feeling of security, however since a persons home does not produce income, the persons equity in their home is not being used productively.

FIG. 1 shows a current saving scheme in which a person 703 receives 702 an income from a business or an employer 701. The person 703 saves 705 a proportion of the income received at 702 in a personal savings fund 706. This fund is typically administered by a bank or a similar organisation. The money in the fund 706 is invested 707 in a personal investment vehicle 708, and yields 709 a return on the investment, this return accumulating in the fund 706. At retirement the person 703 is able to withdraw 710 savings 711 that have accumulated in the fund 708.

FIG. 2 shows a spreadsheet representation 900 depicting operation of the savings scheme of FIG. 1. The person 703 has an annual income of $150,000 (see column B row 2, hereinafter referred to by the shortened notation B2) and this income is incremented at 3% per annum (see B3). The person 703 contributes 9% per year (see B4) of their income towards savings. The column A7- A21 shows a time span of 15 years, during which time the salary of the person 703 increases from $150K in year one (see B7) to $226,888 in year fifteen (see B21). The annual saving contributions depicted by 705 in FIG. 1 increase accordingly from $13,500 in the first year to $20,419.96 in the fifteenth year (see C7-C21). In year one the investment vehicle 708 returns an amount of $675—(see E7) on the $13,500 (see D7) in the fund, and this investment return adds to the savings contribution of $13,905 (see C8) in year 2, thus growing the savings in a compound interest fashion. Under this compounding effect, the balance in the fund 706 in FIG. 1 starts at $13,500 in year one (see D7), and accumulates to a total of $351,648.51 in year fifteen (see D21), this being the amount available to the person 703 after fifteen years of savings.

When such people approach or reach retirement age, they often have fully or largely paid up homes but may have insufficient income upon which to live, this income being derived from sources such as the savings arrangement described in relation to FIGS. 1 and 2. Financial products such as reverse mortgages are available, enabling the retiree to “convert” some of the value of their home into income. However, such existing products can be expensive and inconvenient.

FIG. 3 illustrates one prior art arrangement 100 for providing retirement benefits based on a reverse mortgage. A retiree 101 has a home 102 that has either been wholly or partially paid up during his or her working life. The retiree 101 makes a request 104 to a bank 103, or other financial institution, in order to obtain retirement benefits based on the collateral (ie., security) provided by the retirees home 102. The bank 103 takes security 105 based on the retirees equity in the house 102 in order to provide the retirement benefits in the form of a reverse mortgage. An agreement (not shown) is reached between the retiree 101 and the bank 103 setting out the relevant conditions of the reverse mortgage.

The bank 103 approves the loan as depicted by an arrow 106 and, for illustrative purposes, places funds to support the requested retirement benefits in a loan account 107. Regular payments 108 are made to the retiree 101 from the loan account 107. Accumulating interest charges that are calculated on a compound basis are accumulated, as depicted by an arrow 109, in an illustrative interest account 110.

The regular payments 108 are provided to the retiree 101 for the number of years set out in the agreement between the retiree 101 and the bank 103. Throughout the term of this arrangement interest accumulates per 109 on a compound basis. At the end of the agreed term, the retiree 101 repays, as depicted by an arrow 111, the loan including capital and the accrued interest from 110.

FIG. 4 is a spread-sheet of cash flows for the arrangement of FIG. 3. The spreadsheet is based on the following assumptions:
the equity in the home 102 in FIG. 3 is $1,000,000.00 (see B2 in the spreadsheet)
the amount of the loan requested by the retiree is $450,000.00 (see B3);
the compound interest charged by the bank 103 is 8.95% (see B4).

the term of the loan is 15 years (see B5);
the annual payment 108 provided by the bank 103 to the retiree 101 is $30,000.00 (see B6).

Considering year 1 (see A9) a payment (ie a retirement benefit) of $30,000.00 (ie., B9) is provided, as depicted by the arrow 108 in FIG. 3, to the retiree 101 by the bank 103. Accordingly, the capital owed by the retiree 101 to the bank 103 (ie., C9) is $30,000.00. The interest owed on the aforementioned payment, based upon the interest rate of 8.95% (ie., B4) is $2,685.00 (ie., D9). Accordingly, at the end of the first year the total amount owed by the retiree 101 to the bank 103 is $32,685.00 (ie., E9) this being made up of the capital owed (ie., C9) plus the interest accrued (ie., D9).

At the beginning of year 2 (ie., A10) an amount of $30,000.00 (ie., B10) is again provided, as depicted by the arrow 108, to the retiree 101 by the bank 103. For illustration in the present description it is assumed that payments are made regularly from the bank 103 to the retiree 101 on an annual basis. Clearly, however, payments can be made on a monthly or any other reasonable basis without changing the nature of the disclosed method. At the end of year 2 the retiree 101 owes capital of $60,000.00 (ie., C10) and interest of $5,610,31 (ie., D10). The interest owed at the end of the second year (ie., D10) is derived by applying the rate of 8.95% (ie., B4) to the total of (a) the payment 108 that was made to the retiree 101 in year 2 (ie., B10) plus (b) the total owed at the end of year 1 (ie., E9). Accordingly, the total amount owed by the retiree 101 at the end of year 2 is $68,295.31 (ie., E10).

At the beginning of year 15 (ie., A23) a payment of $30,000.00 (ie. B23) is made to the retiree 101 by the bank 103. This brings the total capital owed by the retiree 101 to the bank 103 to $450,000.00 (ie., C23). The interest owed for year 15 is $78,524.99 (ie., D23) which is determined by applying the interest rate of 8.95% (ie., B4) to the total of (a) the payment for year 15 (ie., B23) plus (b) the total amount owed at the end of year 14 (ie., E22). Therefore, the total amount owed by the retiree at the end of year 15 is $955,899.24 (ie. E23). This constitutes the amount owed by the retiree 101 to the bank 103 at the end of the 15 year arrangement described in relation to FIG. 3.

In summary, the reverse mortgage arrangement described in relation to FIGS. 3 and 4 provides the retiree with an annual retirement benefit of $30,000.00 for a term of 15 years, after which the retiree owes the bank 103 an amount of $955,899.24 (ie. E23). Since the starting equity in the retirees home 102 was $1,000,000.00 (ie (B2) in FIG. 4), this arrangement leaves the retiree with $44,100.76 after paying back the loan to the bank 103.

### SUMMARY

It is an object of the present invention to substantially overcome, or at least ameliorate, one or more disadvantages of existing arrangements. The arrangements disclosed in the specification that ameliorate one or more disadvantages of existing arrangements have one or both of two distinct elements, respectively referred to as an “equity based retirement savings” element and an “life expectancy retirement annuity” element.

Disclosed are arrangements (referred to generally as equity based arrangements or vehicles), preferably implemented in automated or semi-automated computer-based form, which seek to enable a person to derive additional benefits from equity they have or are building in their family home or other assets, these benefits being derived by:
i) using a proportion of the equity in their home to secure a loan which is repaid by (a) periodically repaying an interest charge defined as a fixed proportion of the capital (otherwise known as simple interest) and (b) repaying the capital at the end of the term;
ii) investing the loan at a (compound interest) rate-of-return that is higher than the simple interest referred to in (i); and
iii) directing earnings from the investment in (ii) in various ways depending upon the ‘vehicle’ being chosen, this choice being typically a function of the person's stage in life. According to one arrangement, where the person wishes to use the equity in their home to improve their savings, the person may elect to use the equity in what is referred to as an equity-based retirement savings vehicle as described in relation to FIG. 6. According to another arrangement, where the person wishes to use the equity in their home to provide them with a regular income stream, the person may elect to use the equity in what is referred to as a life-expectancy retirement annuity vehicle as described in relation to FIG. 9.

According to a first aspect of the present invention, there is provided a computer-based system for providing equity based benefits to a person dependent upon equity in property owned by the person, said system comprising:

a memory for storing a program; and

a processor for executing the program, said program comprising:

(a) code for securing a loan secured by a proportion of the equity, the loan having a principal value for a defined term;

(b) code for repaying the loan by periodically paying a simple interest charge being a fixed proportion of the principal;

(c) code for investing a residual of the loan;

(d) code for, if an equity-based retirement savings option is elected, accumulating earnings from the invested residual of the loan; and

(e) code for, if a life-expectancy retirement annuity option is elected, making a periodic payment from the residual of the loan; wherein the principal value of the loan becomes due for repayment at the end of the term.

According to another aspect of the present invention, there is provided a computer program product including a computer readable medium having recorded thereon a computer program for directing a processor to execute a method for providing equity based benefits to a person dependent upon equity in property owned by the person, said program comprising:

(a) code for securing a loan secured by a proportion of the equity, the loan having a principal value for a defined term;

(b) code for repaying the loan by periodically paying a simple interest charge being a fixed proportion of the principal;

(c) code for investing a residual of the loan;

(d) code for, if an equity-based retirement savings option is elected, accumulating earnings from the invested residual of the loan; and

(e) code for, if a life-expectancy retirement annuity option is elected, making a periodic payment from the residual of the loan; wherein the principal value of the loan becomes due for repayment at the end of the term.

According to another aspect of the present invention, there is provided a computer-based system for providing equity based benefits to a person dependent upon equity in property owned by the person, said system comprising:

(a) means for securing a loan secured by a proportion of the equity, the loan having a principal value for a defined term;

(b) means for repaying the loan by periodically paying a simple interest charge being a fixed proportion of the principal;

(c) means for investing a residual of the loan;

(d) means for, if an equity-based retirement savings option is elected, accumulating earnings from the invested residual of the loan; and

(e) means for, if a life-expectancy retirement annuity option is elected, making a periodic payment from the residual of the loan; wherein the principal value of the loan becomes due for repayment at the end of the term.

According to another aspect of the present invention, there is provided a method for providing equity based benefits to a person dependent upon equity in property owned by the person, said method being implemented on a computer based system comprising at least one program running on a corresponding at least one computer platform, said method comprising the steps of:

securing a loan secured by a proportion of the equity, the loan having a principal value for a defined term;

repaying the loan by periodically paying a simple interest charge being a fixed proportion of the principal;

investing a residual of the loan;

if an equity-based retirement savings option is elected, accumulating earnings from the invested residual of the loan; and

if a life-expectancy retirement annuity option is elected, making a periodic payment from the residual of the loan; wherein the principal value of the loan becomes due for repayment at the end of the term.

According to another aspect of the present invention, there is provided a method of generating, for the benefit of a person and a service provider, periodic payments dependent upon equity in property of the person, the method comprising the steps of:

(a) obtaining from a financier a loan secured by the equity, the loan having a principal value and being for a term defined by a number of periods;
(b) investing the loan in a first investment vehicle that yields a first return for each said period on the amount invested; the method further comprising, for a current said period, the steps of:
   (i) withdrawing a first fixed proportion and a second fixed proportion of the principal value from the residual of the loan invested in the first investment vehicle;
   (ii) paying the first fixed proportion to the financier;
   (iii) deducting a charge from said second fixed proportion, said charge comprising the benefit for the service provider;
   (iv) investing for the benefit of the person the residual of the second fixed proportion in an investment vehicle yielding a second return for the current period, said second return being lower than the first return;

(c) repeating the steps (i)-(iv) for said number of periods; and

(d) repaying, by the person to the financier at the end of the term, the principal of the loan.

According to another aspect of the present invention, there is provided a method of generating, for a retiree, periodic payments secured by equity in the retiree's home, the method comprising the steps of:

(a) obtaining, by a service provider from a financier, a loan having a principal value for a defined term, wherein the loan is secured by the equity in the retiree's home;

(b) periodically paying, by the service provider to the financier over the term, a simple interest repayment comprising a payment equal to a first fixed proportion of said principal value;

(c) paying, by the service provider to the retiree, the periodic payments;

(d) charging the retiree by the service provider, in regard to each said periodic payment, a simple interest charge comprising a charge equal to a second fixed proportion of said each said periodic payment;

(e) investing, by the service provider, a residual of the loan, in an investment vehicle yielding a return at a compound rate on said residual of the loan, said residual of the loan being dependent upon the simple interest payments made by the service provider to the financier in the step (b) and the periodic payments made by the service provider to the retiree in the step (c) and the simple interest charges paid by the retiree to the service provider in the step (d); and

(f) repaying, by the retiree to the financier at the end of the term, the principal of the loan.

According to another aspect of the present invention, there is provided a method of generating, for a person, periodic payments secured by equity in property of the person, the method comprising the steps of:

(a) obtaining, from a first provider, a loan having a principal value for a defined term wherein the loan is secured by the equity;

(b) periodically paying, to the first provider over the term, an interest payment equal to a first fixed proportion of said principal value;

(c) paying, to the person, the periodic payments;

(d) charging the person, in regard to each said periodic payment, a charge equal to a second fixed proportion of said each said periodic payment;

(e) investing a residual of the loan, in an investment vehicle yielding a return at a compound rate on said residual of the loan, said residual of the loan being dependent upon the amounts paid in the steps (b) and (c) and the amount received in the step (d); and

(f) repaying, to the first provider at the end of the term, the principal of the loan.

According to another aspect of the present invention, there is provided a system for generating, for a retiree, periodic payments secured by equity in the retiree's home, the system comprising:

(a) means for obtaining, by a service provider from a financier, a loan having a principal value for a defined term, wherein the loan is secured by the equity in the retiree's home;

(b) means for periodically paying, by the service provider to the financier over the term, a simple interest repayment comprising a payment equal to a first fixed proportion of said principal value;

(c) means for paying, by the service provider to the retiree, the periodic payments;

(d) means for charging the retiree by the service provider, in regard to each said periodic payment, a simple interest charge comprising a charge equal to a second fixed proportion of said each said periodic payment;

(e) means by which the service provider invests a residual of the loan, in an investment vehicle yielding a return at a compound rate on said residual of the loan, said residual of the loan being dependent upon the simple interest payments to the financier in the step (b) and the periodic payments to the retiree in the step (c) and the simple interest charges paid by the retiree in the step (d); and

(f) means for repaying, by the retiree to the financier at the end of the term, the principal of the loan.

According to another aspect of the present invention, there is provided a computer program product having a computer readable medium having at least one computer program module recorded therein for directing at least one processor to implement a method of generating, for a retiree, periodic payments secured by equity in the retirees home, the at least one program module comprising:

(a) code for obtaining, by a service provider from a financier, a loan having a principal value for a defined term, wherein the loan is secured by the equity in the retiree's home;

(b) code for periodically paying, by the service provider to the financier over the term, a simple interest repayment comprising a payment equal to a first fixed proportion of said principal value;

(c) code for paying, by the service provider to the retiree, the periodic payments;

(d) code for charging the retiree by the service provider, in regard to each said periodic payment, a simple interest charge comprising a charge equal to a second fixed proportion of said each said periodic payment;

(e) code for investing a residual of the loan, in an investment vehicle yielding a return at a compound rate on said residual of the loan, said residual of the loan being dependent upon the simple interest payments to the financier in the step (b) and the periodic payments to the retiree in the step (c) and the simple interest charges paid by the retiree in the step (d); and

(f) code for repaying, by the retiree to the financier at the end of the term, the principal of the loan.

According to another aspect of the present invention, there is provided a computer based method of generating, for a person, periodic payments secured by equity in property of the person, the method comprising the steps of:

(a) obtaining, from a first provider, a loan having a principal value for a defined term, wherein the loan is secured by the equity;

(b) periodically paying, to the first provider over the term, an interest payment equal to a first fixed proportion of said principal value;

(c) paying, to the person, the periodic payments;

(d) charging the person, in regard to each said periodic payment, a charge equal to a second fixed proportion of said each said periodic payment;

(e) investing a residual of the loan, in an investment vehicle yielding a return at a compound rate on said residual of the loan, said residual of the loan being dependent upon the amounts paid in the steps (b) and (c) and the amount received in the step (d); and

(f) repaying, to the first provider at the end of the term, the principal of the loan; wherein:

(g) if the compound rate in the step (e) falls below a first threshold, an additional loan amount needed to compensate for the reduced compound rate, and associated interest, is capitalized and added to the principal of the loan to be repaid to the first provider in the step (f).

According to another aspect of the present invention, there is provided a system for administering an equity based arrangement of generating, for a person, periodic payments secured by equity in property of the person, the system comprising:

(a) means for obtaining, from a first provider, a loan having a principal value for a defined term, wherein the loan is secured by the equity;

(b) means for periodically paying, to the first provider over the term, an interest payment equal to a first fixed proportion of said principal value;

(c) means for paying, to the person, the periodic payments;

(d) means for charging the person, in regard to each said periodic payment, a charge equal to a second fixed proportion of said each said periodic payment;

(e) means for investing a residual of the loan, in an investment vehicle yielding a return at a compound rate on said residual of the loan, said residual of the loan being dependent upon the amounts paid in the steps (b) and (c) and the amount received in the step (d); and

(f) means for repaying, to the first provider at the end of the term, the principal of the loan; wherein:

(g) if the compound rate in the step (e) falls below a first threshold, an additional loan amount needed to compensate for the reduced compound rate, and associated interest, is capitalized and added to the principal of the loan to be repaid to the first provider in the step (f).

According to another aspect of the present invention, there is provided a computer based system for administering an equity based arrangement of generating, for a person, periodic payments secured by equity in property of the person, the system comprising:

a plurality of memory modules for storing a corresponding plurality of inter-related application program modules; and

a plurality of processor modules for executing the program modules, said program modules comprising:

(a) code for obtaining, from a first provider, a loan having a principal value for a defined term, wherein the loan is secured by the equity;

(b) code for periodically paying, to the first provider over the term, an interest payment equal to a first fixed proportion of said principal value;

(c) code for paying, to the person, the periodic payments;

(d) code for charging the person, in regard to each said periodic payment, a charge equal to a second fixed proportion of said each said periodic payment;

(e) code for investing a residual of the loan, in an investment vehicle yielding a return at a compound rate on said residual of the loan, said residual of the loan being dependent upon the amounts paid in the steps (b) and (c) and the amount received in the step (d); and

(f) code for repaying, to the first provider at the end of the term, the principal of the loan; wherein:

(g) if the compound rate in the step (e) falls below a first threshold, an additional loan amount needed to compensate for the reduced compound rate, and associated interest, is capitalized and added to the principal of the loan to be repaid to the first provider in the step (f).

According to another aspect of the present invention, there is provided a computer program product including at least one computer readable medium having recorded thereon a plurality of inter-related computer application program modules for directing a plurality of processor modules to execute a method for generating, for a person, periodic payments secured by equity in property of the person, said program modules comprising:

(a) code for obtaining, from a first provider, a loan having a principal value for a defined term, wherein the loan is secured by the equity;

(b) code for periodically paying, to the first provider over the term, an interest payment equal to a first fixed proportion of said principal value;

(c) ode for paying, to the person, the periodic payments;

(d) code for charging the person, in regard to each said periodic payment, a charge equal to a second fixed proportion of said each said periodic payment;

(e) code for investing a residual of the loan, in an investment vehicle yielding a return at a compound rate on said residual of the loan, said residual of the loan being dependent upon the amounts paid in the steps (b) and (c) and the amount received in the step (d); and

(f) code for repaying, to the first provider at the end of the term, the principal of the loan; wherein:

(g) if the compound rate in the step (e) falls below a first threshold, an additional loan amount needed to compensate for the reduced compound rate, and associated interest, is capitalized and added to the principal of the loan to be repaid to the first provider in the step (f).

According to another aspect of the present invention, there is provided a plurality of inter-related computer application program modules for directing a plurality of processor modules to execute a method for generating, for a person, periodic payments secured by equity in property of the person, said program modules comprising:

(a) code for obtaining, from a first provider, a loan having a principal value for a defined term, wherein the loan is secured by the equity;

(b) code for periodically paying, to the first provider over the term, an interest payment equal to a first fixed proportion of said principal value;

(c) code for paying, to the person, the periodic payments;

(d) code for charging the person, in regard to each said periodic payment, a charge equal to a second fixed proportion of said each said periodic payment;

(e) code for investing a residual of the loan, in an investment vehicle yielding a return at a compound rate on said residual of the loan, said residual of the loan being dependent upon the amounts paid in the steps (b) and (c) and the amount received in the step (d); and

(f) code for repaying, to the first provider at the end of the term, the principal of the loan; wherein:

(g) if the compound rate in the step (e) falls below a first threshold, an additional loan amount needed to compensate for the reduced compound rate, and associated interest, is capitalized and added to the principal of the loan to be repaid to the first provider in the step (f).

According to another aspect of the present invention, there is provided a periodic payment made to a person using any one of the aforementioned methods or systems.

Other aspects of the invention are also disclosed.

### BRIEF DESCRIPTION OF THE DRAWINGS

Some aspects of the prior art and one or more embodiments of the present invention will now be described with reference to the drawings and appendices, in which:

FIG. 1 shows a current savings arrangement;

FIG. 2 is a spread sheet showing a quantitative example of how the arrangement of FIG. 1 operates;

FIG. 3 illustrates one prior art arrangement for providing retirement benefits based on a reverse mortgage;

FIG. 4 is a spread-sheet of cash flows for the prior art arrangement of FIG. 3;

FIG. 5 shows a process flow by which a person can select one of the equity based vehicles described in relation to FIGS. 6, 9, and 12;

FIG. 6 illustrates one process example of the disclosed equity based savings/investment vehicle (also referred to as the equity based retirement savings arrangement);

FIG. 7 shows a process flow for a business model by which the system of FIG. 6 may be used;

FIG. 8 is a spread sheet showing a quantitative example of how the arrangement of FIG. 6 operates;

FIG. 9 illustrates one process example of the disclosed equity based retirement vehicle (also referred to as the life expectancy retirement annuity arrangement);

FIG. 10 shows a process flow for a business model by which the system of FIG. 9 may be used;

FIG. 11 is a spread-sheet of cash flows for the arrangement of FIG. 9; and

FIG. 12 depicts another process example of the disclosed equity based retirement vehicle in which the equity based retirement savings arrangement can be used with the life expectancy retirement annuity technique;

FIG. 13 is a spread-sheet of cash flows for the arrangement of FIG. 12;

FIG. 14 is a schematic block diagram of an interconnected computer system upon which described methods for providing the disclosed equity-based arrangements can be practiced;

FIG. 15 is a spreadsheet showing parameters used in a switching arrangement example;

FIG. 16 shows a spreadsheet representation of the parameters referred to in FIG. 15 over the term of the loan;

FIG. 17 is a pictorial representation of the “benchmark” parameters in FIG. 16;

FIG. 18 is an expanded pictorial representation of the representation in FIG. 17;

FIG. 19 shows a spreadsheet representation of “non-benchmark” parameters establishing Scenario 1;

FIG. 20 is a pictorial representation of the benchmark curve overlaid on the corresponding non-benchmark curve of Scenario 1;

FIG. 21 shows a spreadsheet depiction for non-benchmark parameters for Scenario 2;

FIG. 22 is a pictorial representation of the benchmark curve overlaid on the corresponding non-benchmark curve of Scenario 2; and

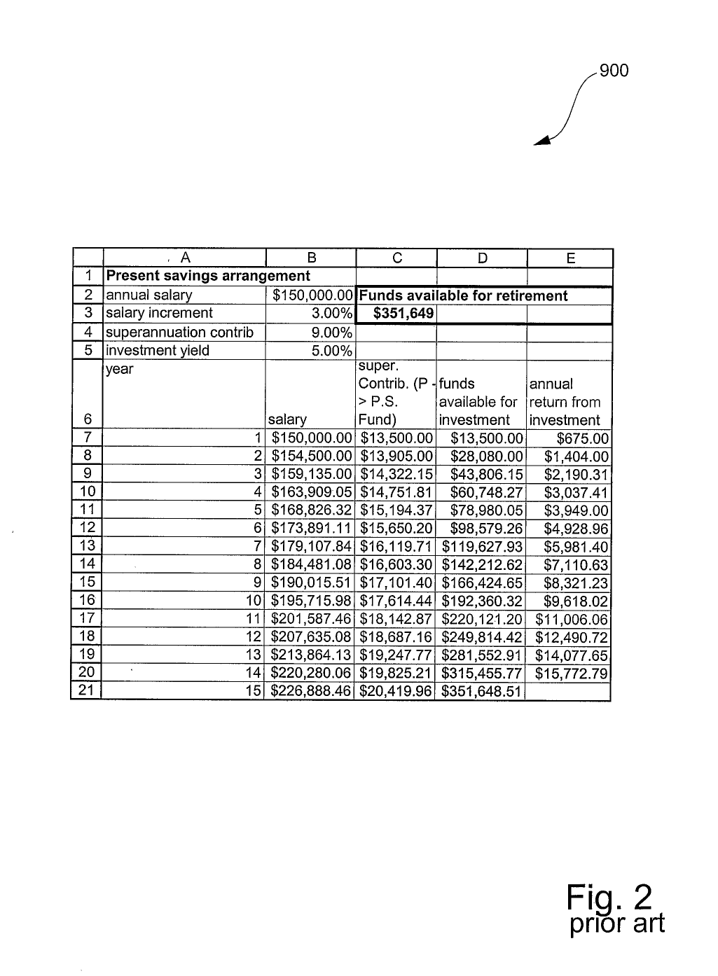

Appendix A contains Formula Representations of Spreadsheets in FIGS. 2, 4, 8, 11, 13, 15, 16, 19, and 21.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

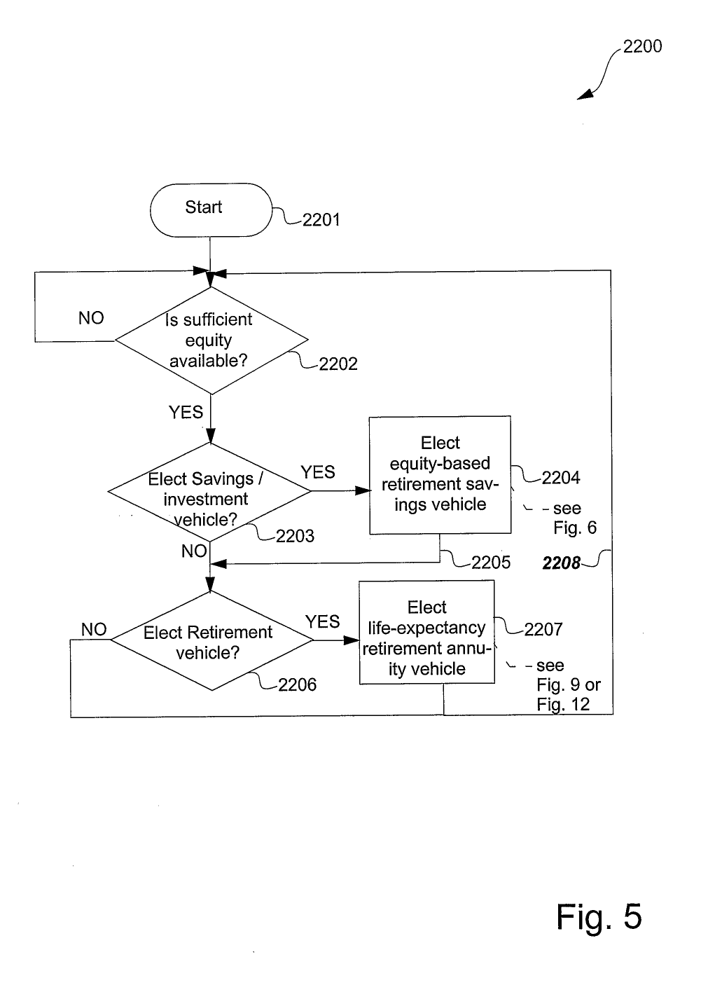

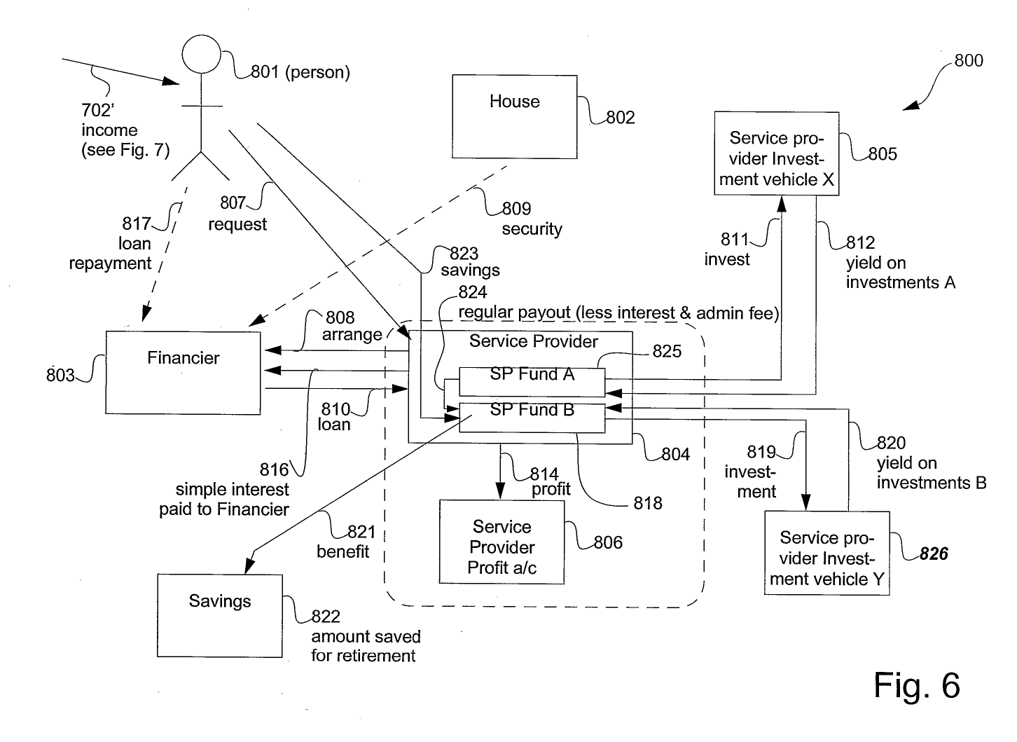

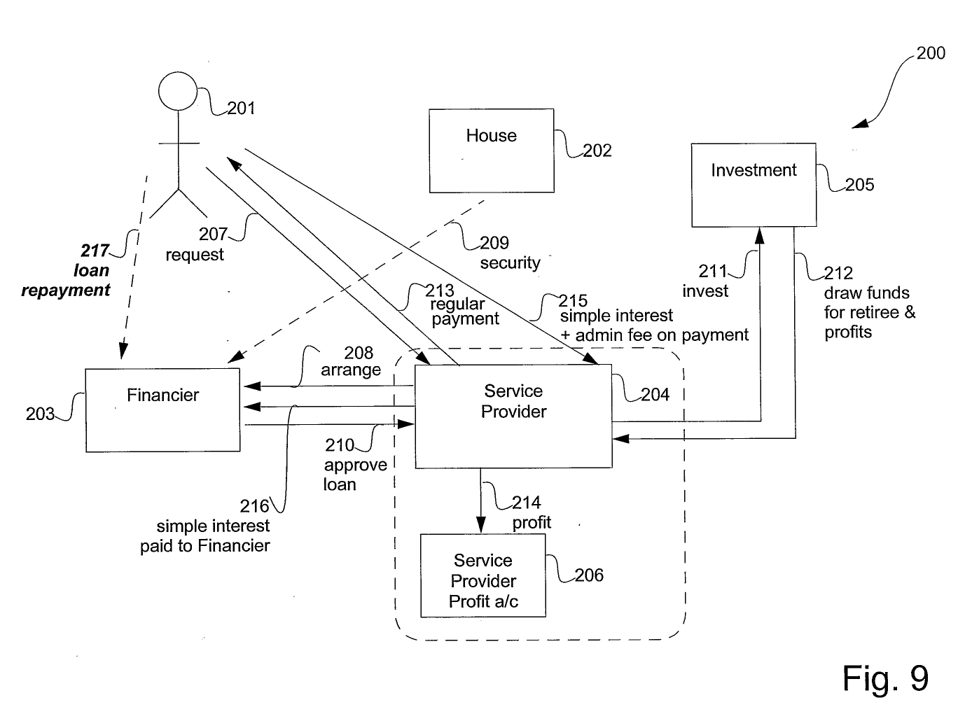

FIG. 5 shows a process flow by which a person (also referred to as the applicant) can select one of the equity based vehicles described in relation to FIGS. 6, 9, and 12. A process 2200 commences at a step 2201 after which a step 2202 determines if the equity available to the person in question is sufficient to use the disclosed equity based arrangements. This is typically performed by one or more of the steps of (a) checking the industry available records for the applicant in regard to previous credit performance, (b) ensuring that the asset/liability ratio for the applicant falls within acceptable limits, taking into account the personal details of the applicant on an actuarial basis, (c) taking into account any further demographic or applicable industry metrics that may be applicable. The aforementioned assessment will typically be determined by the financier or the service provider (203 or 204 respectively in FIG. 9). If insufficient equity is available, the process 2200 loops back to the step 2202 indicating, in practical terms, that the person needs to acquire more equity before he or she can use the disclosed arrangements.

If the step 2202 indicates that sufficient equity is available, then the process 2200 is directed to a step 2203 in which the loan is issued, and the step 2203 further determines if the person wishes to elect an equity based savings/investment vehicle such as the equity-based retirement savings vehicle. If this is the case, then the process 2200 is directed to a step 2204 (see FIG. 6 for further details) which implements the savings/investment vehicle. This choice would, for example, typically be made by a “baby-boomer” who has acquired considerable equity in their family home but is still receiving a salary from an employer and/or investment income from other investments.

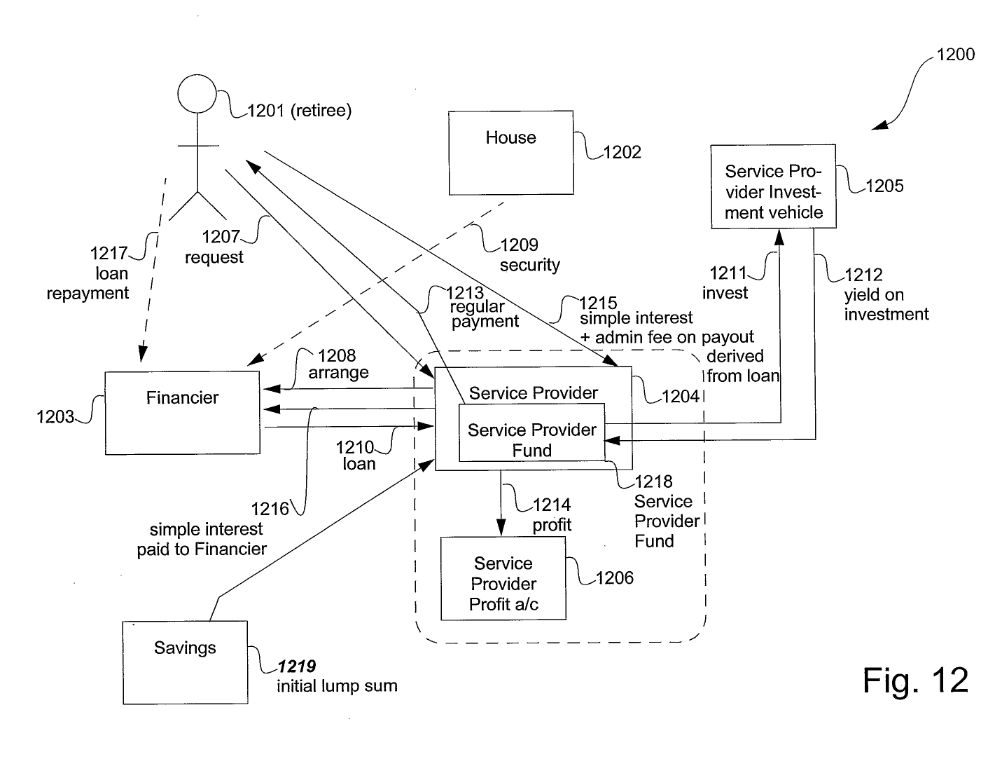

Returning to the step 2203, if the savings/investment vehicle is not to be elected, then the process 2200 is directed to a step 2206 which determines if the retirement vehicle is to be elected. This would, for example, typically be elected by a retiree who wishes to receive an ongoing income stream in retirement. If this election is chosen, then the process 2200 is directed from the step 2206 to a step 2207 (see FIG. 9 or 12 for more detail) which implements the equity based retirement vehicle. The process is then directed back to the step 2202 so that the person in question can, if they wish, make farther choices. Returning to the step 2206, if the equity based retirement vehicle is not elected, then the process is then directed back to the step 2202 so that the person in question can, if they wish, make further choices.

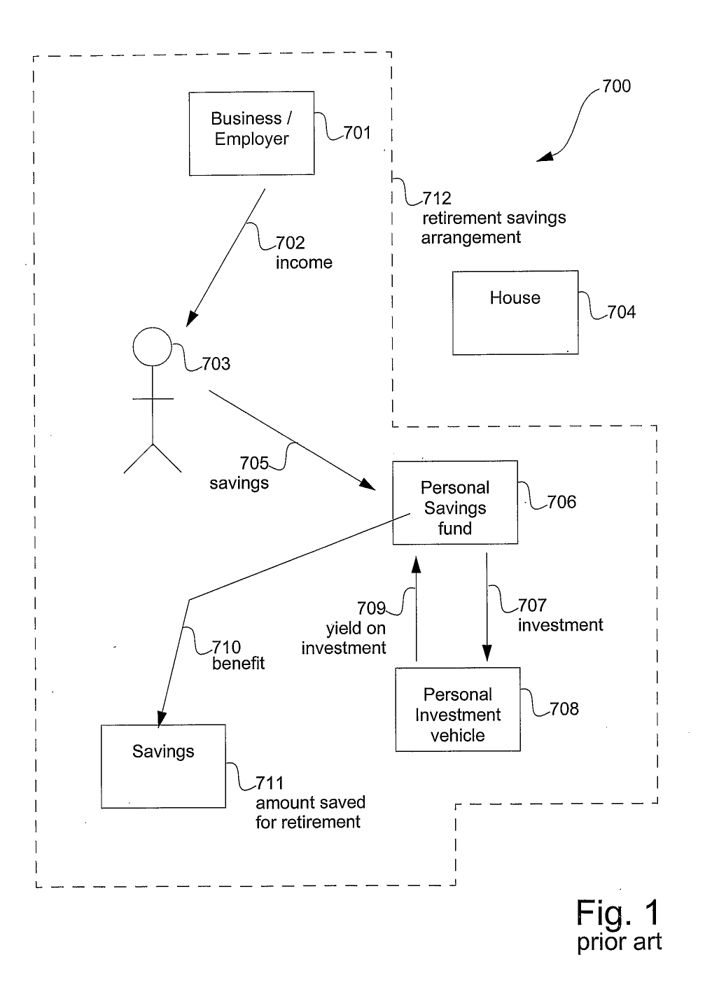

FIG. 6 illustrates one example of the disclosed equity based retirement savings arrangement. A person 801 receives 702′ an income as depicted by an arrow 702 in FIG. 1. The person has equity in property, typically in a home 802. The person 801 requests 807 a Service Provider 804 for a loan based on security derived from the equity the person 801 has in the house 802. The Service Provider 804 arranges 808 a loan from a financier 803, and security, possibly in the form of a mortgage on the house 802, is taken 809 by the financier 803. The financier 803 transfers 810 the requested loan funds to the service provider.

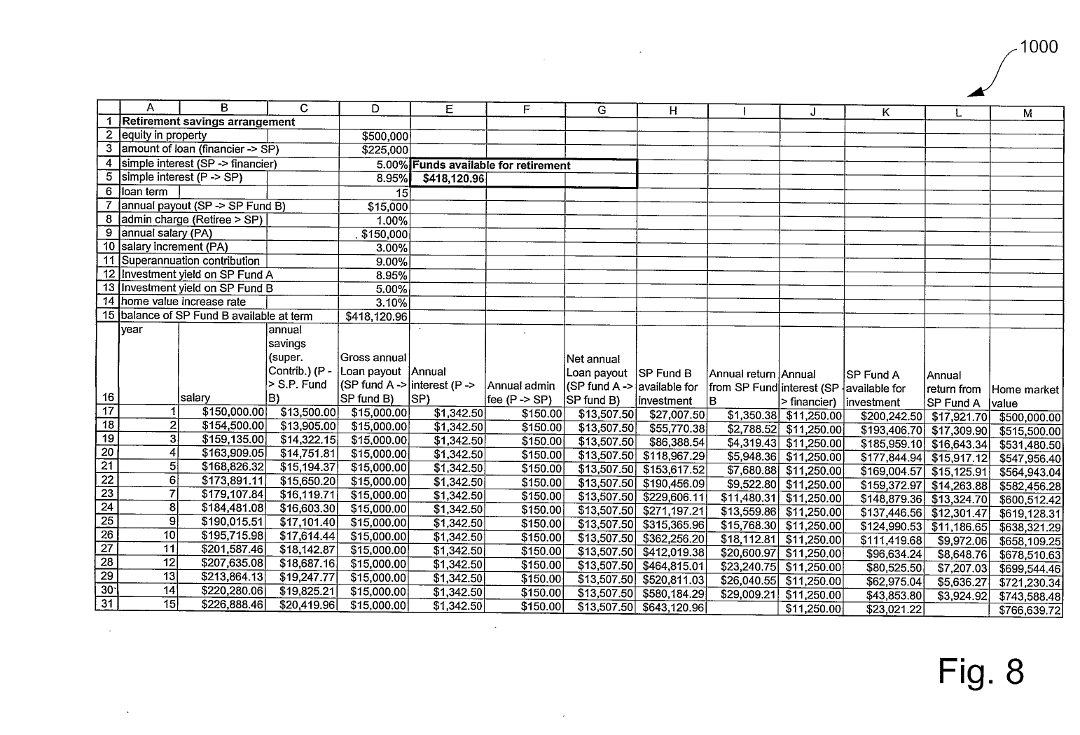

The terms of the aforementioned loan require that a fixed charge, equal to a predetermined proportion of the total loan amount provided by the financier 803, be paid 816 to the financier on a regular basis. This type of arrangement is referred to as a simple interest arrangement. The service provider 804 manages two funds, referred to as Fund A (ie 825), and Fund B (ie 818). The service provider deposits the aforementioned loan into Fund A from which funds are invested 811 by the service provider 804 in high yield, moderate to high risk investment vehicles X (ie 805), yielding 812 a healthy 8.95% rate of return (see D12 in FIG. 8) per annum in the example depicted in FIG. 8. Fund B is a lower yield “blue chip” find from which money is invested 819 in lower yield lower risk investment vehicles Y (ie 826), yielding 820 a more conservative 5.00% rate of return (see D13 in FIG. 8) per annum in the example depicted in FIG. 8. The service provider 804 derives 814 profits from managing the aforementioned funds, and accumulates these profits in a profit account 806. These profits provide one of the commercial returns upon which the service provider 804 builds the service provider's business.

The person 801 makes 823 regular savings contributions (eg see C17 in FIG. 8) to the blue chip Fund B (ie 818). The service provider makes 824 regular payouts (eg based on D17 in FIG. 8) into the same Fund B. These regular payouts into the Fund B derive from the loan made 810 by the financier 803 on the basis of the security taken 809 over the person's house 802. The regular payouts are made after the service provider deducts a number of charges including a fixed charge that is proportional to the amount of the payout (eg see E17 in FIG. 8), and an administration charge that is also proportional to the amount of the payout (eg see F17 in FIG. 8). The manner in which the administration charge is determined can vary, and can, for example, be calculated on the basis of a fixed proportion of the loan amount (see D3 in FIG. 8). Accordingly, a net payout (eg G17 in FIG. 8) is made 824 by the service provider 804 into the Fund B (ie 818 in FIG. 8). The Fund B (ie 818) accordingly grows in a low risk manner, accumulating both the regular contributions made 823 by the person 801 from the income they are continuing to receive 702′, and also accumulating the regular net payouts (eg G17 in FIG. 8) made 824 by the service provider 804. The assets in the Fund A (ie 825) that derive from the loan received 810 in regard to the equity in the house 802 receive 812 high growth yield from the investment vehicle X (ie 805) but undergo a net decrease with time by virtue of providing 824 the net payouts to Fund B (ie 818) over the term of the loan.

At the end of the term (see D6 in FIG. 8) of the loan, the person 801 repays 817 the principal of the loan to the financier 803. The net funds that are available to the person c801 at this point are determined by subtracting the principal of the loan (ie D3 in FIG. 8) from the total amount (ie H31 in FIG. 8) that has been accumulated in the Fund B (ie 818). This net amount in the example of FIG. 8 is $418,120 (ie D15 in FIG. 8).

The funds that are thus available represent 821 a lump sum 822 that can be used by the person 801 when he or she retires. The specific manner in which the savings 822 are used can be decided by the person 801, however one particularly beneficial way in which the saving 822 can be used are described in relation to FIG. 12.

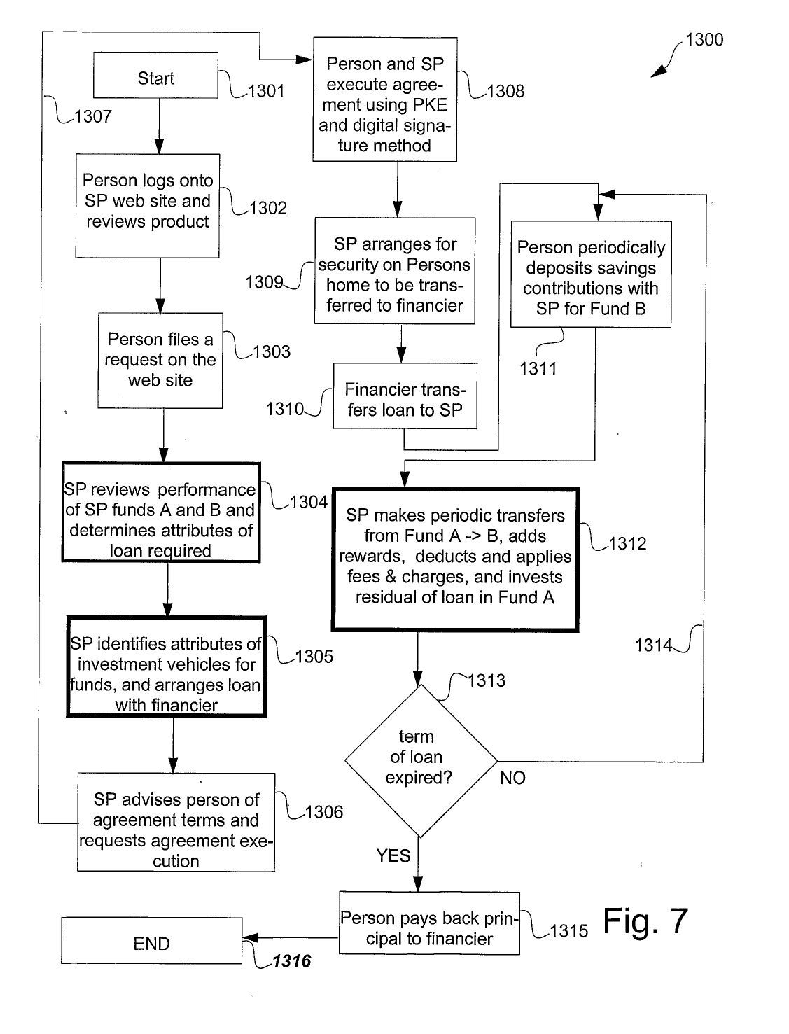

FIG. 7 shows a process 1300 for a business model by which the system of FIG. 6 may be used. The process 1300 commences with a START step 1301, after which the person 801 logs onto a website (not shown) of the service provider 804 in order to review the product offerings presented by the service provider. In a following step 1303 the person 801 files a request electronically on the aforementioned website. Thereafter, in a step 1304, the service provider 804 firstly assesses the asset and liability profile of the person 801 to determine if the person 801 is eligible for one or more of the equity-based offerings. The service provider 804 reviews the current performance statistics of the funds A and B (ie 825 and 818 respectively), in order to decide how to select the risk profiles to be used when making investments from the Fund A (ie 825) and the Fund B (ie 818) at 811 and 819 respectively. The step 1304 thus conducts an actuarial analysis of the current performance of the funds A and B (ie 825 and 818 respectively), in order to determine if the finds A and B are presently (a) not meeting, (b) meeting, or (c) exceeding the pre-determined performance parameters.

The following step 1305 identifies the attributes of the investment vehicles to be used for investing the elements of the proposed loan based upon the historic fund performance parameters determined in the step 1304. The steps 1304 and 1305 are shown in bold outline in FIG. 7 in order to indicate that analysis, usually actuarial, of fund parameters are being performed.

The following description relates specifically to Fund A (ie 825) and the high growth investment vehicle X (ie 805). The same approach is typically used, in an independent manner, in regard to the Fund B (ie 818) and the investment vehicle Y (ie 826).

If the fund A (ie 825) is presently meeting it's pre-defined earning target, then the service provider 804 will provide the new applicant (ie the person 801) with a new loan whose residual value is to be invested (depicted by 811 in FIG. 6) in investment vehicles X (ie 805) having the same risk level, and thus the same likely return level, as the previous investment vehicles selected for the previous person who applied for the product provided by the service provider 804. This selection is made in order to ensure that the fund A continues to remain on track, thus meeting it's pre-defined target performance metrics.

In contrast, if the fund A is presently not meeting it's pre-defined earnings target, then the service provider 804 will provide the person 801 with a new loan whose residual value is to be invested at 811 in investment vehicles X (ie 805) having a higher risk level, and thus higher likely returns, than the previous investment vehicles selected for the previous person who applied for the product provided by the service provider 804. This selection is made in order to ensure that the fund A improves its performance, thus moving towards meeting its pre-defined target performance metrics.

If the fund A is presently exceeding it's pre-defined earnings target, then the service provider 804 will provide the person 801 making the new application with a loan whose residual value is to be invested at 811 in investment vehicles X (ie 805) having a lower risk level, and thus a lower likely return, than the corresponding investment vehicles used for the previous fund applicant. This selection is made in order to ensure that the fund A reduces its performance, and its corresponding risk, thus moving towards meeting it's pre-defined target performance metrics.

Since there are two funds, namely A and B (ie 825 and 818 respectively), the approach described for the fund A (ie 825) can equally be applied to the fund B (ie 818). This must, however, account for the fact that the fund A (ie 825) operates at a generally higher level of risk and return that the fund B (ie 818).

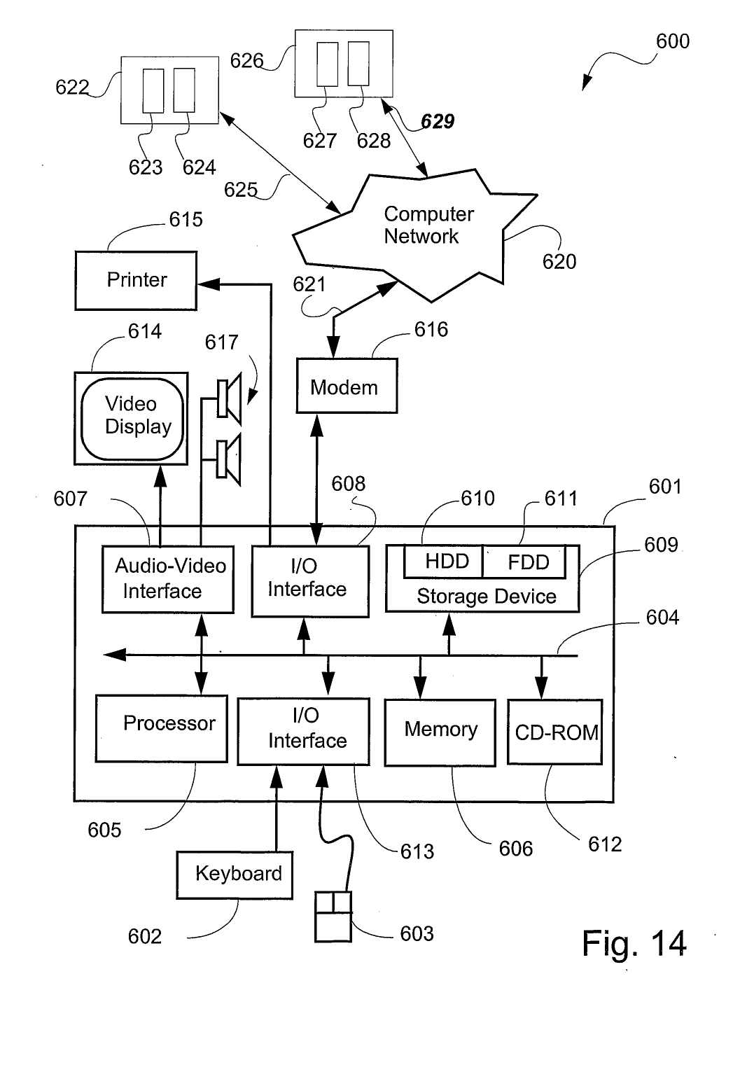

A following step 1306 sends, over the communications network 620 (see FIG. 14) to the PC 601 of the person 801, an electronic agreement for joining the arrangement provided by the service provider 804. In a following step 1308 the person 801 executes the agreement, using appropriate security mechanisms, and sends the executed agreement to the PC 622 of the service provider 804 over the network 620. In a subsequent step 1309, the service provider 804 arranges, electronically over the network 620, with the person 801 and the financier 803, to execute the necessary electronic documents required to transfer (depicted as 809 in FIG. 6) the necessary security over the appropriate equity in the person's home 802 to a PC 626 of the financier 203.

The financier then, in a following step 1310, transfers (per 810 in FIG. 6) the relevant loan funds to the service provider 804. In a following step 1311, the person 801 makes 823 a periodic deposit as a savings contribution with the service provider 804 to be deposited into the fund B (ie 818). In a subsequent step 1312, the service provider makes 824 a periodic payment on behalf of the person 801 into the fund B (ie 818), after adding any reward or bonus points which may be appropriate, and deducting any fees and charges which may be appropriate.

It is noted that the periodic payments made 824 to the find B (ie 818) on behalf of the person 801 may, in one arrangement, be fixed and independent of the performance of the funds A and/or B. In an alternate arrangement, the periodic payment made 824 may be dependent, at least to some degree, upon the performance of the aforementioned funds. The step 1312 is shown in bold outline to indicate that actuarial calculations may be performed upon the funds A and B in order to determine the amount of the periodic payment made at 824, and the amount of any reward or bonus points, to be paid on behalf of the person 801. The step 1312 also applies the fees and charges as appropriate, and invests (per 811 and 819 in FIG. 6) the residual of the loans the finds A and B (ie 825 and 818 respectively) in the investment vehicles X and Y respectively (ie 805 and 826) according to the risk profiles determined in the steps 1304 and 1305.

In the step 1312 the service provider 804 can also draw the necessary funds from the funds A and/or B to pay (per 816 in FIG. 6) the simple interest payments to the financier 803. Alternatively the simple interest payments to the financier 803 can be paid on a periodic basis not directly coupled to the periodic payments made (per 824 in FIG. 6) on behalf of the person 801.

A following test step 1313 determines if the term of the loan has expired. If this is the case, then the process 1300 is directed by a YES arrow to a step 1315 in which the person 801 repays (per 817 in FIG. 6) the principal of the loan to the financier 803. The process then terminates with an END step 1316. Returning to the decision step 1313, if the term of the loan has not yet expired, then the process 1300 is directed according to a NO arrow back to the step 1311.

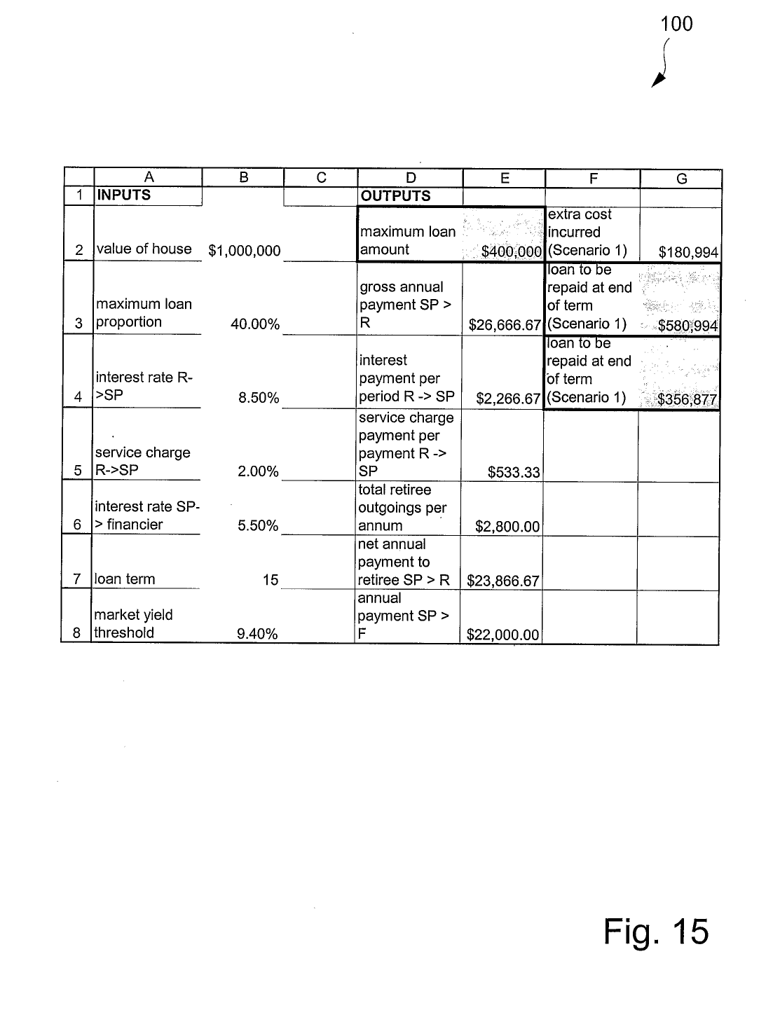

If the switching arrangement described in relation to FIGS. 15-22 are implemented, then the step 1312 also deals with capitalization of the performance deficit cost (resulting from poorer than expected performance of the investment vehicles 805 and/or 826 in FIG. 6) and with accumulation of the excess performance benefits (resulting from better than expected performance of the investment vehicles 805 and/or 826 in FIG. 6). The step 1315 also takes into account the performance deficit cost and/or the excess performance benefit as appropriate.

FIG. 8 is a spread sheet showing a quantitative example of how the arrangement of FIG. 6 operates. The spreadsheet is based on the following assumptions:
The equity of the person 801 in the house 802 in FIG. 6 is $500,000.00 (see D2);
The amount of the loan provided 810 by the financier 803 to the service provider 804 is $225,000.00 (see D3);
The simple interest paid at 816 in FIG. 6 by the service provide 804 to the financier 803 is 5% (see D4);
The simple interest paid by the person 801 to the service provider 804 on each regular payment 824 is 8.95% (see D5);
The term of the loan is 15 years (see D6);
The periodic payout at 824, prior to deduction of interest and administration fees, made by the service provider 804 into the fund B (ie 818) is $15,000.00 (see D7);
The administration charge paid by the person 801 to the service provider 804 on each of the aforementioned payments is 1% (see D8);
The annual income at 702′ received by the person 801 is $150,000.00 (see D9);
The annual salary increment received by the person 801 on their income is 3% (see D10);
The periodic contribution made by the person 801 at 823 into the fund B (ie 818) is 9% (see D11) of their income 702′;
The investment yield provided 812 by the investment vehicle X (ie 805) on investments made 811 from fund A (ie., 825) in FIG. 6 is 8.95% (see D12);
The investment yield provided 820 by the investment vehicle Y (ie. 826) on investments made 819 from fund B (ie., 818) in FIG. 6 is 5% (see D13); and

The annual rate of increase in the value of the house 802 is 3.1% (see D14).

Turning to the table comprising the columns A-M and the rows 16-31, the figures in row 17 are described as follows in order to describe the operation of the described arrangement. In year 1 (ie., A17) the person 801 receives 702′ a salary of $150,000.00 (ie., B17). The person 801 makes a contribution of $13,500.00, this being 9% (ie., D11) of his or her salary (ie., B17). This contribution is deposited 823 by the person 801 into find B (ie. 818). This savings stream exemplified by C17 represents an ongoing stream of savings by the person 801 into their fund B over the term of the loan (ie. D6).

A periodic payment of $15,000.00 (ie., D17) is allocated for payment by the service provider 804 into fund B (ie. 818) this $15,000.00 deriving from the loan received by the person 801 from the financier 803. This $15,000.00 is a gross allocation, and before the service provider 804 transfers this amount from fund A (ie 825) to fund B (ie., 818), as depicted by the arrow 824, the service provider 804 deducts an interest charge (ie., E17) and an administration charge (ie., F17) in order to arrive at the amount of $13,507.50 which is the net payment at 824 from the fund A (ie 825) to the fund B (ie 818). The interest deduction at E17 is calculated by applying the simple interest at D5 to the gross payout at D17. The administration fee at F17 is determined by applying the administration fee rate at D8 to the payout at D1 7.

Column H depicts how fund B (ie 818) grows over the term of the loan. Fund B receives both the income stream depicted by column C (ie., the ongoing savings component from the person 801 based on their income 702′) and the net periodic payment in column G which is derived from the loan received by the person 801 from the financier 803. Thus, for example, the $27,007.50 in fund B in year 1 (ie., H17) earns an amount of $1,350.38 (ie., 117) by virtue of the investment yield on fund B (ie., D13) acting on the $27,007.50. The last entry in column H, namely $643,120.96 is the amount accumulated by the end of the 15 year term in fund B. From this amount the principal of the loan, namely $225,000.00 (ie., D3) is deducted in order to arrive at the amount of the funds available for retirement for the person 801, this being $418,120.96 (ie., E5).

From the perspective of the service provider 804, and having regard to row 17 which relates to year 1 of the arrangement shown in FIG. 8, the service provider 804 pays an amount of $11,250.00 (J17) to the financier 803, this amount being determined by applying the simple interest of 5% (ie., D4) to the loan of $225,000.00 (ie., D3). Column J shows that this periodic interest charge paid by the service provider 804 to the financier 803 is constant over the term of the loan.

The service provider 804 has, in the first year, an amount of $200,242.50 available for investment in the investment vehicle X (ie., 805), this amount being shown at K17. This amount is equal to the amount of the original loan (ie., $225,000.00 at D3) minus the annual interest charge owed to the financier (ie., J17) less the gross payout to the person 801 (ie., D17) plus the annual interest charge paid by the person 801 on the aforementioned payout (ie., E17) plus the administration fee paid by the person 801 to the service provider 804 (ie., F17). The investment vehicle X (ie., 805) earns an amount of $17,921.70 (ie., L17) according to the yield (d12) of the investment vehicle X acting on the amount in the vehicle X (ie., K17).

Column M depicts the manner in which the house 802 appreciates in value from its initial value of $500,000.00 (ie., D2) under the influence of the rate of increase of value in the market (ie., D14).

In summary, the disclosed equity based retirement savings arrangement described in relation to FIGS. 6 and 8 provides the person 801 with an amount of $643,120.96 after operating the arrangement for a period of 15 years, after which the person owes the bank 103 an amount of $225,000.00 (ie. the principal of the original loan at D3). Accordingly, this equity based retirement savings arrangement leaves the person with $418,120.06 after paying back the principal of the loan to the financier 203. This is 18.9% more that the conventional savings arrangement described in relation to FIGS. 1 and 2. The service provider derives their profit from one or more elements. One such element is the administration and other charges received from the retiree (per column F in FIG. 8).

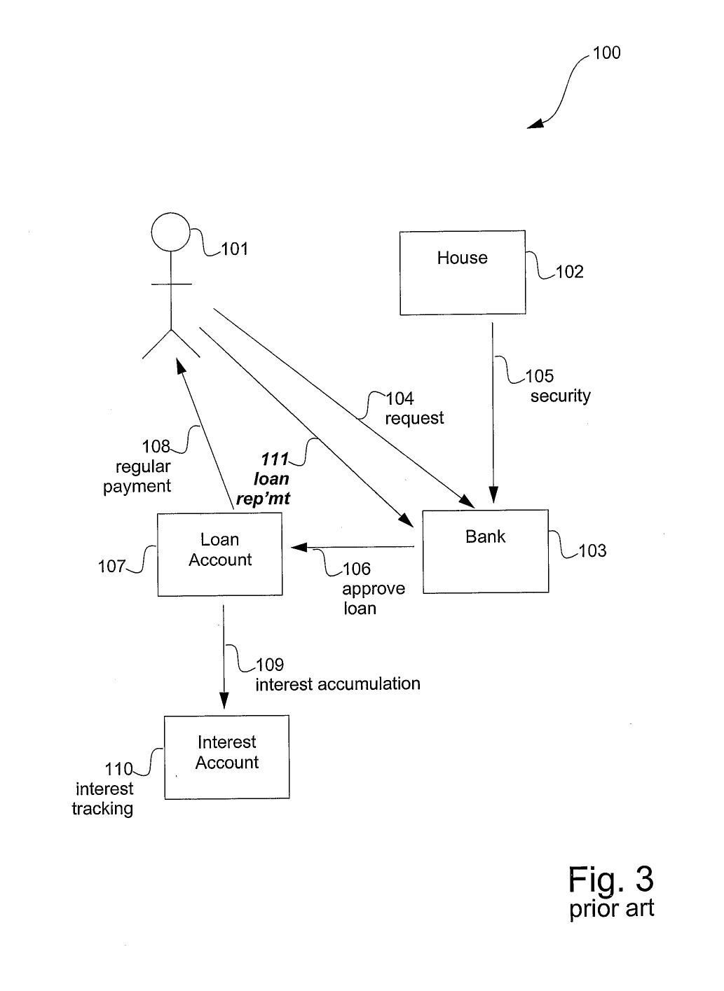

FIG. 9 illustrates one example of the disclosed life expectancy retirement annuity arrangement. In this arrangement 200 a retiree 201 has, similar to the situation described in relation to FIG. 3, a fully or partially paid up home 202. The retiree 201 makes a request as depicted by an arrow 207 to a service provider 204. The service provider 204 arranges, as depicted by an arrow 208, for a loan to be provided at a wholesale interest rate from a financier 203, or from some other wholesale money provider. The financier 203 takes, as depicted by a dashed arrow 209, security on the basis of the equity in the home 202. Thereafter, the financier 203 provides, as depicted by an arrow 210, the loan finds to the service provider 204.

The service provider 204 invests, as depicted by an arrow 211, the loan in investment vehicles 205 that yield a market-based rate of return. The total of the finds invested in the investment vehicles 205 at any time, together with any working capital held by the service provider, substantially constitutes the “Life Expectancy Retirement Annuity Fund”. The service provider 204 draws, as depicted by an arrow 212, funds to be distributed (per 213) to the retiree 201 as well as a profit that the service provider 204 takes (per 214) in respect of services provided. In regard to the profit, an alternative arrangement is for the service provider 204 to derive the profit directly from an administration or other charge paid by the retiree at 215. The service provider 204 provides, as depicted by an arrow 213, regular payments to the retiree 201. The service provider 204 also extracts, as depicted by an arrow 214, the aforementioned profit which is accumulated, for the sake of illustration, in an account 206.

On a periodic basis, the service provider 204 also pays, as depicted by an arrow 216, simple interest to the financier 203 on the total amount of the loan that was provided at 210. The retiree 201 also pays, as depicted by an arrow 215, simple interest on each payment 213 that he or she receives from the service provider 204. This simple interest payment is deducted from the payment to the retiree. This interest payment is simple interest on each payment made, and is not interest on the total amount of the loan provided at 210. Furthermore, the retiree 210 can also pay an administration or other fee, as part of 215, on each payment provided at 213.

The aforementioned process proceeds for the duration of the term originally agreed on between the retiree 201 and the service provider 204. At the end of the aforementioned period, the retiree 201 repays, as depicted by an arrow 217, the capital of the loan to the financier 203, this being the same amount as provided by the financier 203 at 210 at the outset of the aforementioned arrangement. The retiree is not liable for any interest to the financier 203 as the service provider 204 has paid this interest per 216. The repayment 217 of the loan is typically effected through the service provider 204, who receives the money from the retiree 201 and passes it on to the financier 203.

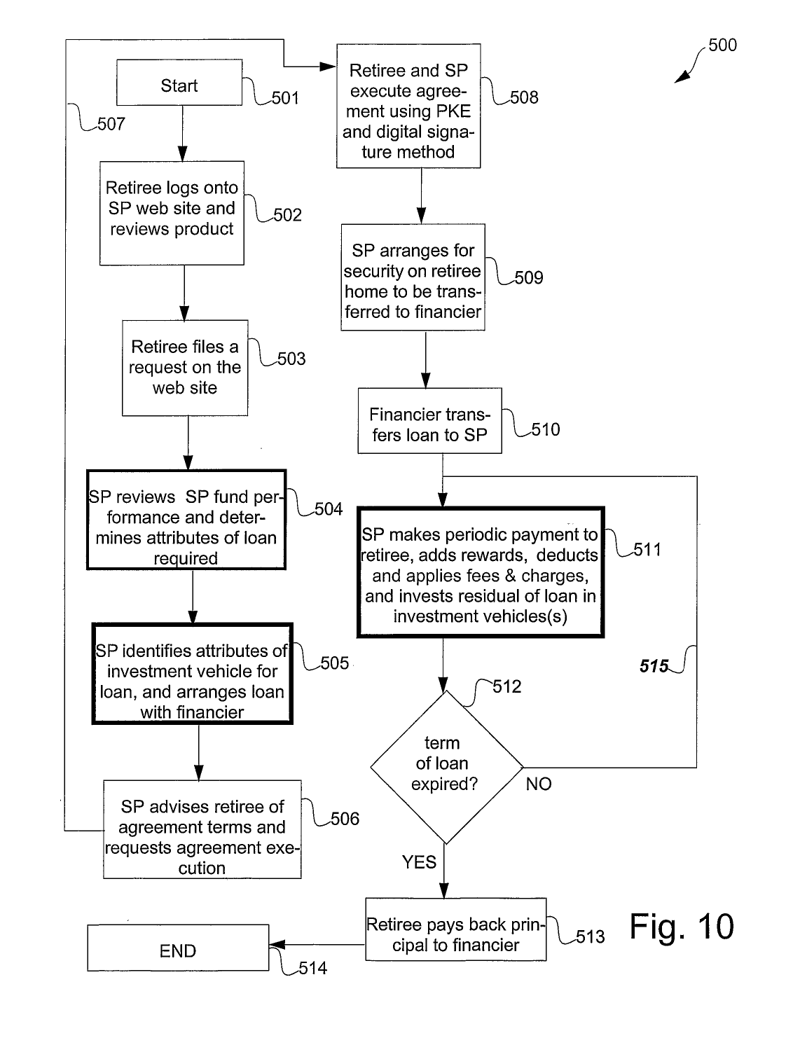

FIG. 10 shows a process flow 500 for a business model by which the system of FIG. 9 may be used. The process 500 commences with a start step 501 after which, in a following step 502, the retiree 201 (see FIG. 9) logs in, using his Personal Computer (PC) (601 in FIG. 14), to the web site of the Service Provider 204 over the communications network (620 in FIG. 14) and reviews the life expectancy retirement annuity product details. In a following step 503 the retiree 201 fills in his or her personal details on a software application form displayed by the web site of the service provider 204. This application form includes details such as loan required (up to 45% of the value of the equity owned by the retiree in their home can be approved), home details, personal information, spouse or de-facto spouse details, and beneficiary under the will. The retiree 201 the gives the appropriate commands via the user interface of the users PC to formally make the request (depicted by the arrow 207 in FIG. 9) to join the life expectancy life expectancy retirement annuity fund. This request is communicated, together with the retiree's personal details, to the computer (622 in FIG. 14) of the service provider 204.

In a following step 504, the service provider 204 reviews the current performance statistics of the life expectancy retirement annuity fund, in order to decide how to select the parameters of the loan to be provided to the retiree. The parameters being referred to relate not to the amount of the regular payments (depicted by 213 in FIG. 3), since the amount of the regular payments 213 are set primarily by the terms of the agreement made between the retiree 201 and the service provider 204. Rather, the parameters of the loan to be provided to the retiree relate to the risk profile to be used when investing the residual of the loan at 211. The step 504 thus reviews the current performance of the life expectancy retirement annuity fund, based upon actuarial analysis of the fund, in order to determine if the fund is presently (a) not meeting, (b) meeting, or (c) exceeding the pre-determined performance parameters.

A following step 505 identifies the attributes of the investment vehicle to be used for investing the residual value of the proposed loan based upon the historic find performance parameters determined in the step 504. The steps 504 and 505 are shown in bold outline in FIG. 10 in order to indicate that analysis of fund parameters are being performed. If the life expectancy retirement annuity fund is presently meeting it's pre-defined earnings targets, then the service provider will provide the “new” retiree with a loan whose residual value is to be invested (depicted by 211 in FIG. 9) in an investment vehicle having the same risk level, and thus the same likely return level, as the previous investment vehicle selected for the previous new fund member. This selection is made in order to ensure that the life expectancy retirement annuity fund continues to remain on track, thus meeting it's pre-defined target performance metrics.

In contrast, if the life expectancy retirement annuity fund is presently not meeting it's pre-defined earnings targets, then the service provider will provide the new retiree with a loan whose residual value is to be invested at 211 in an investment vehicle having a higher risk level, and thus a higher likely return level, than the investment vehicles used for the previous fund applicant. This selection is made in order to ensure that the life expectancy retirement annuity fund improves its performance, thus moving towards meeting it's pre-defined target performance metrics.

If the life expectancy retirement annuity find is presently exceeding its pre-defined earnings targets, then the service provider will provide the new retiree with a loan whose residual value is to be invested at 211 in an investment vehicle having a lower risk level, and thus a lower likely return level, than the investment vehicle used for the previous fund applicant. This selection is made in order to ensure that the life expectancy retirement annuity fund reduces its performance, and it's associated risk, thus moving towards meeting it's pre-defined target performance metrics.

A following step 506 sends, over the communications network 620 to the PC 601 of the retiree 201, an electronic agreement for joining the fund. In a following step 508 the retiree executes the agreement, using appropriate security mechanisms, and sends the executed agreement to the PC (622) of the service provider 204 over the network 620. In a subsequent step 509, the service provider 204 arranges, electronically over the network 620, with the retiree 201 and a suitable financier 203, to execute the necessary electronic documents required to transfer (depicted as 209 in FIG. 9) the necessary security over the appropriate equity in the retiree's home 202 to a PC (626) of the financier 203.

The financier then, in a following step 510, transfers (per 210 in FIG. 9) the relevant loan funds to the service provider. In a following step 511, the service provider makes the periodic payment to the retiree, this possibly being via electronic payment over the network 620, after adding any reward or bonus points which may be appropriate, and deducting any fees and charges which may be appropriate. It is noted that the periodic payment made to the retiree may, in one arrangement, be fixed and independent of the performance of the life expectancy retirement annuity fund as a whole. In an alternate arrangement, the periodic payment may be dependent, at least to some degree, upon the fund performance. The step 511 is shown in bold outline to indicate that actuarial calculations may be performed upon the fund in order to determine the amount of the periodic payment, and the amount of any reward or bonus points, to be paid to the retiree. The step 511 also applies the fees and charges as appropriate, and invests (per 211 in FIG. 9) the residual of the loan in an investment vehicle according to the risk profile determined in the step 505. In the step 511 the service provider can also draw the necessary funds from the life expectancy retirement annuity fund to pay (per 216 in FIG. 9) the simple interest payments to the financier 203. Alternately, the simple interest payments to the financier 203 can be paid on a periodic basis not directly coupled to the periodic payments made (per 213 in FIG. 9) to the retiree.

A following test step 512 determines if the term of the loan has expired. If this is the case, then the process 500 is directed by a YES arrow to a step 513 in which the retiree 201 repays (per 217 in FIG. 9) the principal of the loan back to the financier 203. The process then terminates with a STOP step 514. Returning to the decision step 512, if the term of the loan has not yet expired, then the process 500 is directed according to a NO arrow back to the step 511.

If the switching arrangement described in relation to FIGS. 15-22 is implemented, then the step 511 also deals with capitalization of the performance deficit cost (resulting from poorer than expected performance of the investment vehicles 805 and/or 826 in FIG. 6) and with accumulation of the excess performance benefits (resulting from better than expected performance of the investment vehicles 805 and/or 826 in FIG. 6). The step 513 also takes into account the performance deficit cost and/or the excess performance benefit as appropriate.

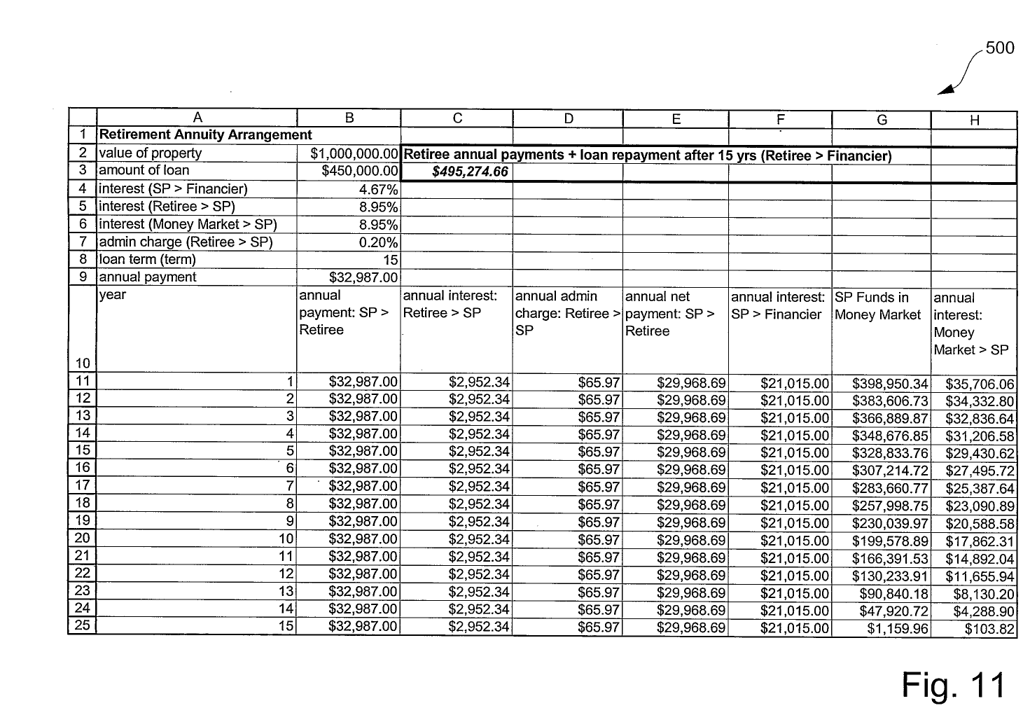

FIG. 11 is a spread-sheet of cash flows for the arrangement of FIG. 9. The spreadsheet is based on the following assumptions:
the equity in the home 202 in FIG. 9 is $1,000,000.00 (see B2 in the spreadsheet in FIG. 11);
the amount of the loan provided by the financier 203 as requested by the retiree is $450,000.00 (see B3);
the simple interest paid at 216 by the service provider 204 to the financier 203 is 4.67% (see B4).
the simple interest on each payment paid by the retiree 201 to the service provider 204 at 215 is 8.95% (ie. B5);
the interest (ie., the yield) on the investment funds provided at 211 from the service provider 204 to investment vehicles 205 is 8.95% (ie. B6);
the administration charge (or other charge) paid by the retiree 201 at 215 to the service provider 204 in respect of, and deducted from, each regular payment at 213 is 0.20% (ie., B7); and
the term of the loan arrangement described in the present example is 15 years (ie. B8).

Turning to the table comprising the columns A-H and the rows 11-25 of the spreadsheet, Column A depicts the year being considered, column B depicts the annual (ie the periodic) payment made by the service provider 204 to the retiree 201, and column C depicts the periodic (interest) payment made at 215 by the retiree to the service provider 204. Column D depicts the periodic (administration fee or other) payment made at 215 by the retiree to the service provider 204, and column E depicts the net amount left in the hands of the retiree 201 after the retiree has received the payment in column B and paid the charges in the columns C and D. Column F depicts the periodic payment made by the service provider 206 to the financier 203, and column G depicts the funds available to the service provider 204 for investment in the investment vehicles 205. Column H depicts the return provided by the investment vehicles 205 on the amount invested (see Column G) each period.

Considering year 1 (ie., A11) a payment of $32,987.00 (ie. B11) is made at 213 from the service provider 204 to the retiree 201. The retiree pays simple interest of $2,952.34 (ie C11) to the service provider 204 at 215, this being simple interest levied on the payment made (ie., B11) at 8.95% (ie., B5). In addition, the retiree 201 pays at 215 an administration fee of $65.97 (ie., D11) this being a charge at 0.20% (ie. B7) levied on the payment made at B11. Accordingly, the net periodic payment in the hand of the retiree 201 after receiving the payment 213 and paying the simple interest and the administration fee 215 is $29,968.69 (ie., E11).

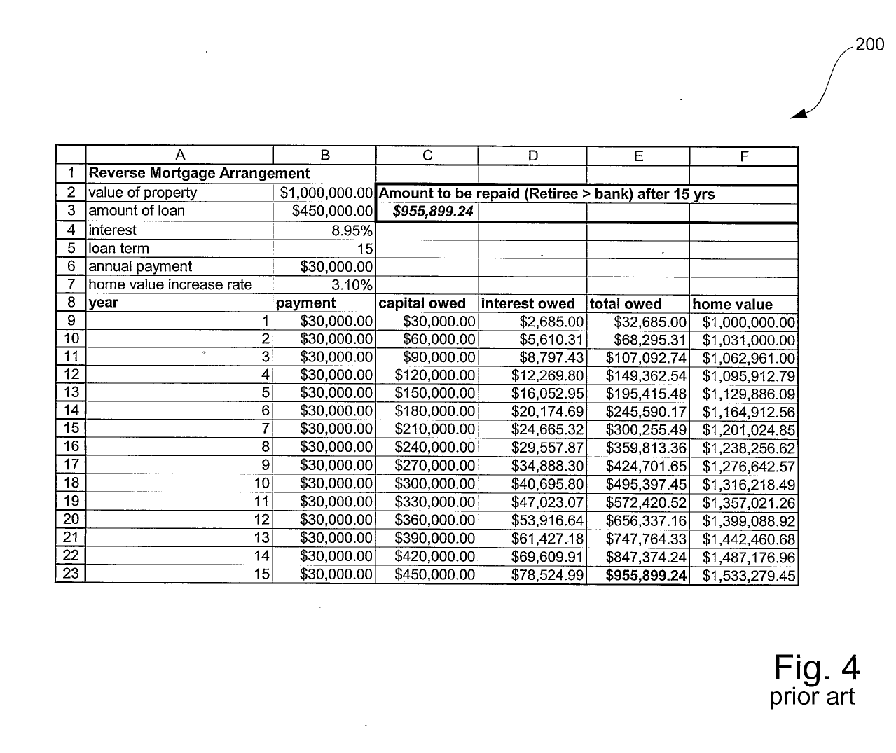

Clearly the various dollar amounts and interest rates can be changed without impacting on the inventive concept, however the numbers have been selected to ensure that the payment in the hands of the retirees 101 and 201 respectively are close enough for a meaningful comparison to be made between the arrangements shown in FIGS. 3 and 4 respectively. It is noted that in regard to FIG. 3 the payment in hand received by the retiree 101 is $30,000.00 per time period, (eg., B9 in FIG. 4) and the payment received in hand by the retiree 201 in FIG. 9 is approximately the same, this being $29,968.69 (eg., E11 in FIG. 11).

The periodic simple interest paid by the service provider 204 to the financier 203 at 216 is $21,015.00 (ie F11). This derives from applying the simple interest rate of 4.67% (ie., B4) to the total loan amount of $450,000.00 (ie., B3).

The amount of money available to the service provider for investment, as depicted by 211, in the investment vehicles 205 is $398,950.34 (ie., G11). This amount is equal to the total loan amount of $450,000.00 (ie., B3) less the payment for year 1 of $32,950.34 (ie., B11) that was made at 213 to the retiree 201, plus the interest payment at 215 paid by the retiree to the service provide 204 (ie., C11) minus the interest payment at 216 paid by the service provider 204 to the financier 203 (ie., F11). The annual yield provided by the investment vehicles 205 is $35,706.06 (ie., H11) which is the rate of 8.95% (ie., B6) acting in a compound manner on the invested funds (ie. G11).

At the beginning of year 2 (ie., A12) the service provider makes the regular payment 213 to the retiree 201 to the amount of $32,987.00 (ie., B12). The retiree 201 pays, at 215, the simple interest of 8.95% (ie., B5) on the aforementioned payment at B12. The retiree 201 similarly pays the periodic administration charge of $65.97 (ie., D12) which derives from the simple interest of 0.20% (ie., B7) applied to the payment of $32,987.00 (ie., B12). The retiree 201 thus has $29,968.69 (ie. E12) in hand, as was the case in year 1 (ie., E11).

The service provider 204 pays the simple interest charge of $21,015.00 at 216 (ie F12) to the financier 203, this deriving from the simple interest of 4.67% (ie. B4) applied to the entire loan value of $450,000.00 (ie., B3). The funds available to the service provider for investing at 211 in the investment vehicles 205 during year 2 amount to $383,606.73 (ie G12). This figure is made up of the amount available during year 1 namely $398,950.34 (ie. G11) plus the earnings from the investment vehicles 205 of $35,706.06 (ie., H11) less the periodic payment of $32,987.00 at 213 to the retiree 201 (ie., B12) plus the interest paid by the retiree 201 of $2,952.34 (ie., C12) less the simple interest charges paid by the service provider 204 at 216 to the financier 203. In summary, therefore, the service provider draws, at 212, an amount of $51,049.67. This reflects the difference between the $398,950.34 invested in the investment vehicles 205 in year 1 (ie., G11) plus the earnings from the investment vehicles 205 of $35,706.06 (ie., H11) minus the amount of finds available for investment in the investment vehicles 205 in year 2, this amount being $383,606.73 (ie., G12).

At the beginning of year 15 (ie., A25) the regular payment 213 is made to the retiree 201 (ie., B25), and the retiree 201 pays the simple interest charge at 215 to the service provider 204 (ie., C25). The retiree 201 also makes the periodic administration payment at D25 to the service provider 204, thus having the amount of $29,968.69 in hand at E25. The service provider 204 makes the final interest payment of $21,015.00 (ie., F25) at 216 to the financier 203, leaving only $1,159.96 at G25 for investment in the investment vehicles 205. This situation constitutes the end of the particular agreement between the retiree 201 and the service provider 204. Accordingly, the retiree 201 pays back the principal of the loan ie., $450,000.00 (ie., B3), as depicted by 217, to the financier 203.

In the present example, the profit at 214 for the service provider 204 derives purely from the annual administration payments at 215 from the retiree 201 (ie., D11-D25). According to another example, the profit 214 can be derived from the funds drawn at 212.

In summary, the disclosed life expectancy retirement annuity arrangement described in relation to FIGS. 9 and 11 provides the retiree with an annual life expectancy retirement annuity of $29,968.69 for a term of 15 years, after which the retiree owes the bank 103 an amount of $450,000.00 (ie. the capital of the original loan at B3). It is noted, however, that the retiree has, during the term of the life expectancy retirement annuity arrangement, paid out an amount of $44,285.05 in simple interest charges at 215 in FIG. 9, plus an amount of $989.61 in administration (or other) charges at 215 in FIG. 9. Accordingly, the total amount paid out by the retiree by the end of the relevant term is $495,274.66 (see C3). Since the starting equity in the retirees home 202 was $1,000,000.00 (ie (B2) in FIG. 11, this life expectancy retirement annuity arrangement leaves the retiree with $504,725.34 after paying back the loan to the financier 203. The service provider derives their profit from one or more elements. One such element is the investment (per 211 in FIG. 9) of the initial loan. Other profit elements include the administration and other charges received from the retiree (per 215 in FIG. 9).

The retiree can be made responsible for payment of the approved valuers fees (in consideration for obtaining a valuation of their home 202 prior to obtaining the loan from the financier 203), mortgage costs associated with the obtaining the loan from the financier 203, stamp duty and mortgage insurance.

FIG. 12 depicts one example of how the equity based retirement savings arrangement can be used with the life expectancy retirement annuity technique. As noted in regard to FIG. 6, the person 801 is free to use the lump sum 822 in any manner he or she sees fit, however it is particularly advantageous to incorporate the lump sum into the life expectancy retirement annuity arrangement as an initial lump sum. In some legislative frameworks, this can have additional benefits from the perspective of tax and social security, particularly if the life expectancy retirement annuity funds are classified as “complying funds” for these purposes.

The arrangement in FIG. 12 operates in the same manner as that described in relation to FIG. 9 apart from the fact that the savings 822 accumulated by the person 801 in the equity based retirement savings arrangement of FIG. 6 are applied as an initial lump sum 1219 in FIG. 12. The arrangement shown in FIG. 12 is identical to that described in relation to FIG. 9 except for the aforementioned additional feature. In FIG. 9 the person 201 uses equity in their house 202 in order to secure a loan from the financier 203 which forms the basis of regular payments 213. At the end of the loan period the person 201 in FIG. 9 repays 217 the principal of the loan to the financier 203. In FIG. 12 a retiree 1201 similarly obtains a loan from a financier 1203 on the basis of security 1209 over the house 1202 of the retiree 1201. The aforementioned loan forms the basis for regular payments 1213 from a service provider 1204 to the retiree 1201. However, in FIG. 12 unlike in FIG. 9 the retiree 1201 has an additional initial lump sum 1219 which has been accumulated according to the arrangement 800 in FIG. 6. This lump sum 1219 is incorporated into the arrangement provided by the service provider 1204 and increments the regular payments 1213.

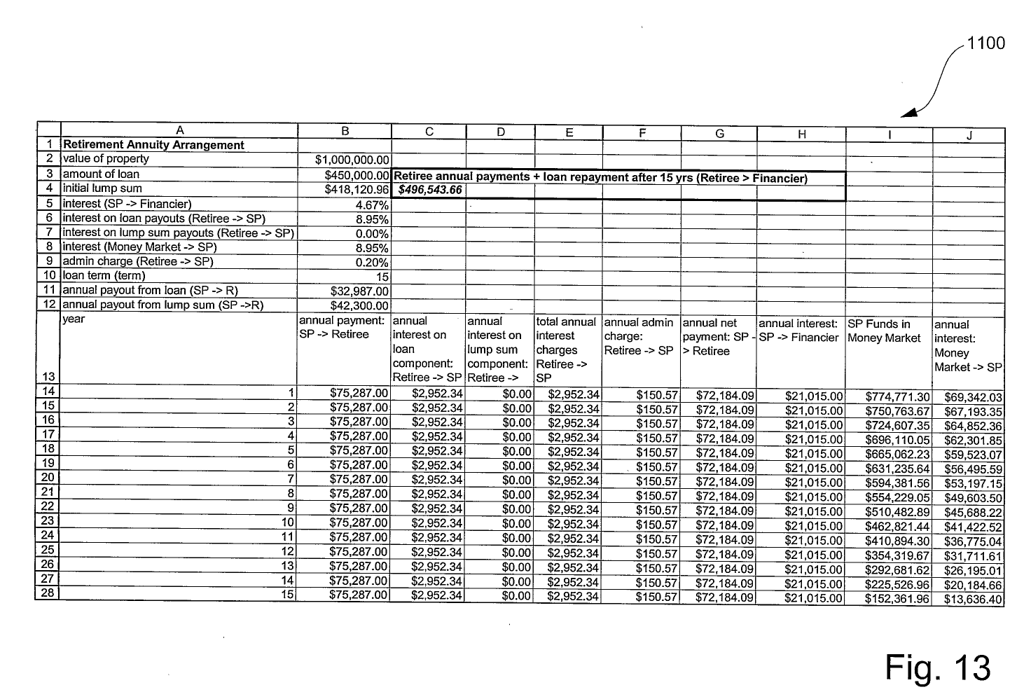

FIG. 13 is a spread-sheet of cash flows for the arrangement of FIG. 12. The cash flows are based on the following assumptions:
the value of the house 1202 is a million dollars (B2);
the amount of the loan received from the financier 1203 is $450,000.00 (ie., B3);
the initial lump sum in 1219 is $418,120.96 (B4). This being the same figure derived in the arrangement in FIG. 8 (see E5);
the simple interest at 1216 paid by the service provider 1204 to the financier 1203 is 4.67% (B5);
the interest paid by the retiree 1201 to the service provider 1204 on the loan component of the regular payment 1213 is 8.95% (B6);
the interest paid by the retiree 1201 to the service provider 1204 on the lump sum component of the regular payment 1213 is 0% (B7);
the rate of return on the funds invested in the investment vehicle 1205 is 8.95% (B8);
the administration charge paid by the retiree 1201 on each regular payment 1213 (this being levied on the entire payment 1213, ie., both the component deriving from the loan and from the lump sum 1219) is 0.2% (B9);
the term of the loan is 15 years (BIO);
the annual gross payout from the service provider to the retiree based upon the loan from the financier is $32,987.00 (B11); and the annual payout from the lump sum 1219 is $42,300.00 (B12).

In year 1 (A14) the retiree 1201 receives a gross payment of $75,287.00 (B14) this deriving both from the annual payment from the loan and from the lump sum (ie., B11 plus B12). On this combined amount the retiree 1201 pays an interest charge to the service provider of $2,952.34 (C14) this interest being levied only on the loan component of the regular payment 1213 ie $32,987 (B11). An amount of zero dollars (D14) is paid by the retiree to the service provider (D14) on the lump sum component 1219 ie $42,300 (B12). Accordingly, the total annual interest charges paid by the retiree to the service provider are $2,952.34 (E14). An additional administration charge of $150.57 (F14) is also deducted from the gross amount of $75,287.00 (at B14) resulting in an annual net payment to the retiree of $72,184.09 (G14). The annual interest charge paid by the service provider to the financier is $21,015.00 (H14) which in the first year leaves an amount of $774,771.30 for investment in the investment vehicle 1205 (114). This earns an annual amount of $69,342.03 in the year 1 (J14).

FIG. 14 is a general-purpose computer system 600, wherein the processes of FIGS. 5, 7, and 10 may be implemented as software, such as one or more application program modules executing within the computer system 600. In particular, the steps implementing the elected equity based vehicle(s) are effected by instructions in the software modules that are carried out by the computers in the computer system 600. The instructions may be formed as one or more code modules, each for performing one or more particular tasks. Each software module may also be divided into two separate parts, in which a first part performs the equity based methods and a second part manages a user interface between the first part and the user. The software modules may be stored in computer readable media, including the storage devices described below, for example. The software modules are loaded into the computers from the computer readable media, and then executed by the computers. A computer readable medium having such software or computer program recorded on it is a computer program product. The use of the computer program products in the computers preferably effects an advantageous apparatus for performing the equity based methods.

The computer system 600 is formed by the retiree (or baby-boomer/investor) computer module 601, the service provider computer module 622, and the financier computer module 626. The following description relates to the retiree (or baby-boomer/investor) computer module 601, however the description applies equally, with relevant modifications, to the service provider computer module 622, and the financier computer module 626.

The retiree (or baby-boomer/investor) computer module 601 also comprises input devices such as a keyboard 602 and mouse 603, output devices including a printer 615, a display device 614 and loudspeakers 617. A Modulator-Demodulator (Modem) transceiver device 616 is used by the computer module 601 for communicating to and from a communications network 620, for example connectable via a telephone line 621 or other functional medium. The modem 616 can be used to obtain access to the Internet, and other network systems, such as a Local Area Network (LAN) or a Wide Area Network (WAN), and may be incorporated into the computer module 601 in some implementations.

The retiree (or baby-boomer/investor) computer module 601 typically includes at least one processor unit 605, and a memory unit 606, for example formed from semiconductor random access memory (RAM) and read only memory (ROM). The service provider computer module 622 typically includes at least one processor unit 623, and a memory unit 624, for example formed from semiconductor random access memory (RAM) and read only memory (ROM). The financier computer module 626 typically includes at least one processor unit 627, and a memory unit 628, for example formed from semiconductor random access memory (RAM) and read only memory (ROM).

The module 501 also includes an number of input/output (I/O) interfaces including an audio-video interface 607 that couples to the video display 614 and loudspeakers 617, an I/O interface 613 for the keyboard 602 and mouse 603 and optionally a joystick (not illustrated), and an interface 608 for the modem 616 and printer 615. In some implementations, the modem 616 may be incorporated within the computer module 601, for example within the interface 608. A storage device 609 is provided and typically includes a hard disk drive 610 and a floppy disk drive 611. A magnetic tape drive (not illustrated) may also be used. A CD-ROM drive 612 is typically provided as a non-volatile source of data. The components 605 to 613 of the computer module 601, typically communicate via an interconnected bus 604 and in a manner which results in a conventional mode of operation of the computer system 600 known to those in the relevant art. Examples of computers on which the described arrangements can be practiced include IBM-PC's and compatibles, Sun Sparcstations or alike computer systems evolved therefrom.

Typically, the application program modules for the retiree (or baby-boomer/investor) computer module 601 is resident on the hard disk drive 610 and read and controlled in its execution by the processor 605. Intermediate storage of the program modules and any data fetched from the network 620 may be accomplished using the semiconductor memory 606, possibly in concert with the hard disk drive 610. In some instances, the application program modules may be supplied to the retiree (or baby-boomer/investor) encoded on a CD-ROM or floppy disk and read via the corresponding drive 612 or 611, or alternatively may be read by the retiree (or baby-boomer/investor) computer module 601 from the network 620 via the modem device 616. Still further, the software can also be loaded into the computer system 600 from other computer readable media. The term “computer readable medium” as used herein refers to any storage or transmission medium that participates in providing instructions and/or data to the computer system 600 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer modules 601, 622 and 626. Examples of transmission media include radio or infra-red transmission channels as well as a network connection to another computer or networked device, and the Internet or Intranets including e-mail transmissions and information recorded on Websites and the like.

The arrangement described in relation to FIG. 9 (and equivalently in relation to FIGS. 6 and 12) presume that the market-based rate-of-return provided by the investment vehicles 205 is constant over the term of the loan.

In one arrangement, both the regular payment 213 to the retiree 201, and the amount of the loan repayment 217 can be “guaranteed” (by the service provider 204 or by another party). In this event, any fluctuations in the rate-of-return of the investment vehicles 205 is not passed on to the retiree 201.

If the rate-of-return is constant over the term of the loan, the funds invested in the investment vehicles 205 reduce smoothly to zero over the term of the loan. This can be seen, for example, by considering the column G in FIG. 11. This depicts, in rows 11-25, the funds in the investment vehicles 205 reducing from $398,950.34 in year 1, through to $1,159.96 (being close to zero) in year 15. This is referred to as the “benchmark” curve.

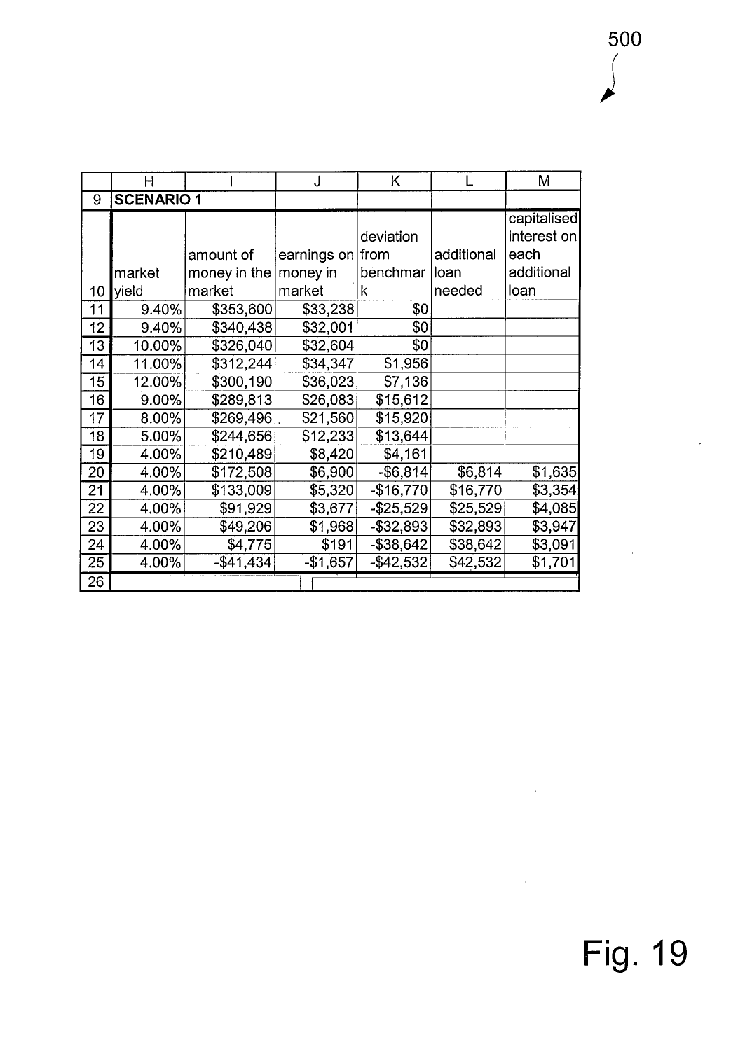

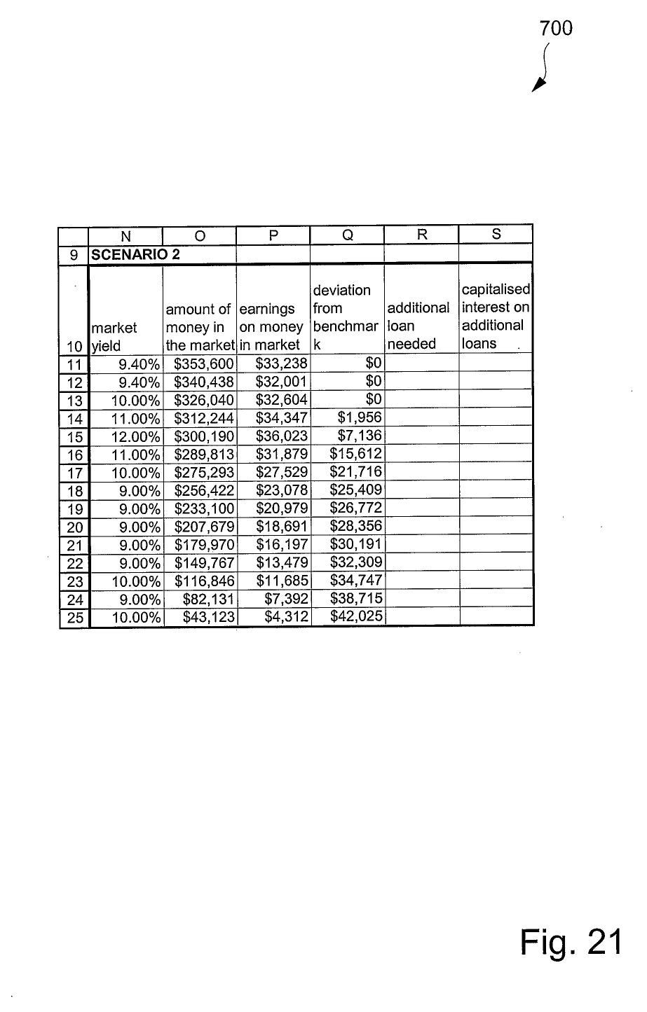

Generally, however, the market-based rate of return of the investments is unpredictable. Accordingly, the rate-of-return of the investment vehicles 205 typically varies with time (as shown in columns H and N of FIGS. 19 and 21).

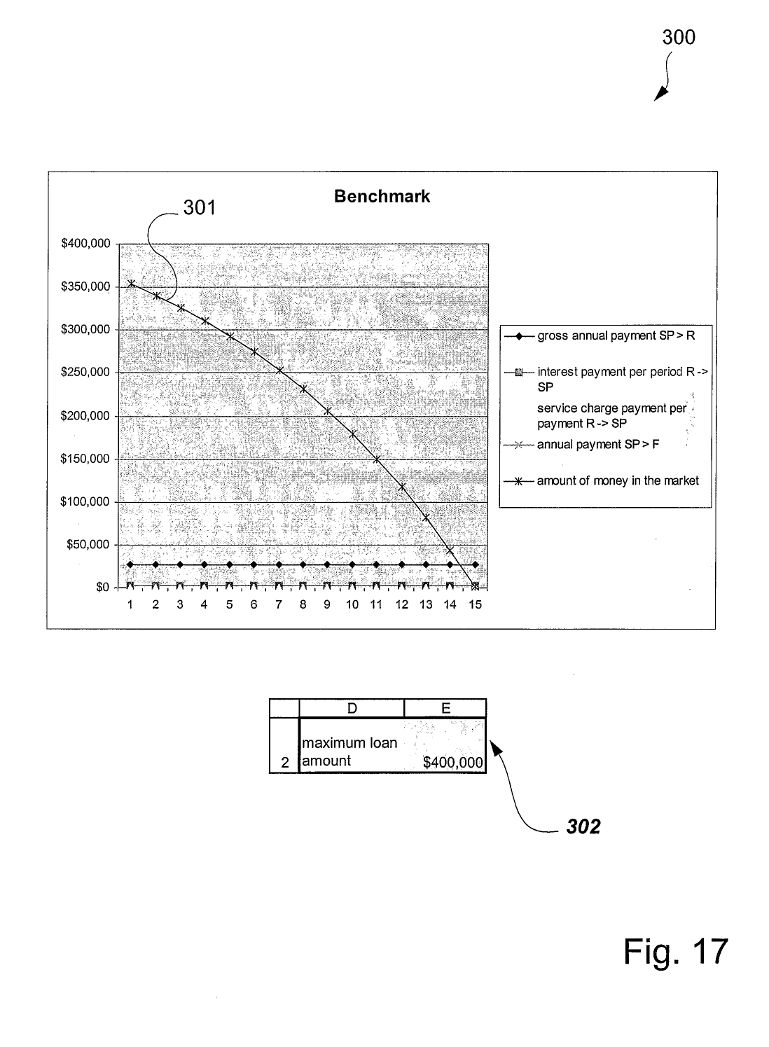

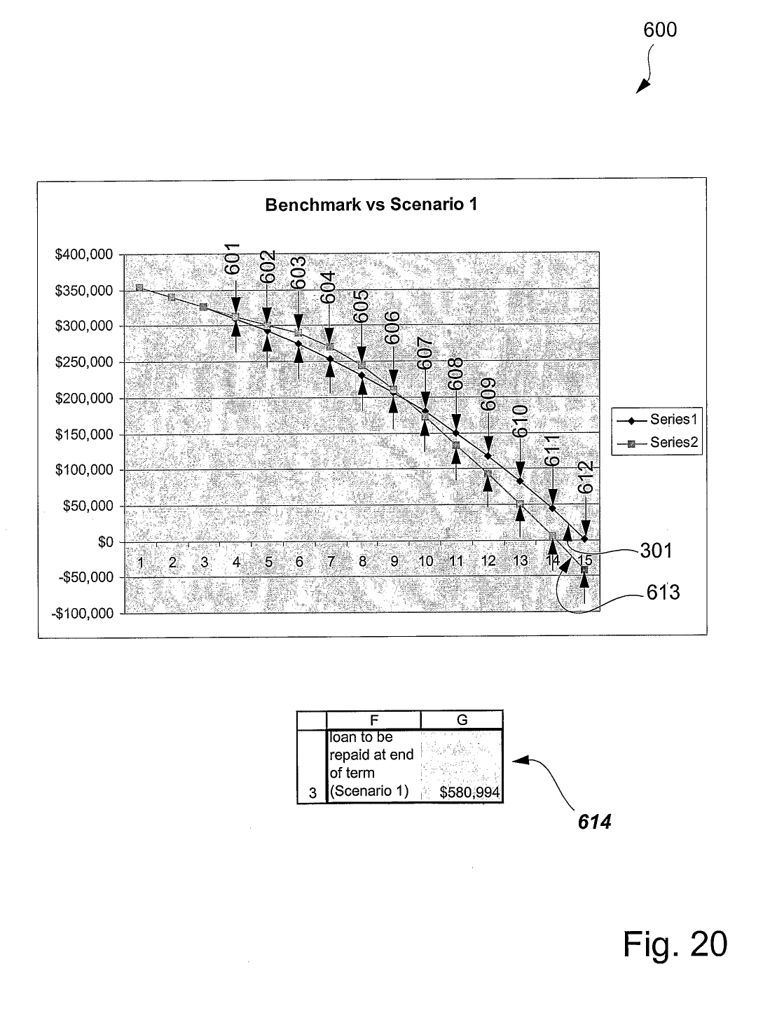

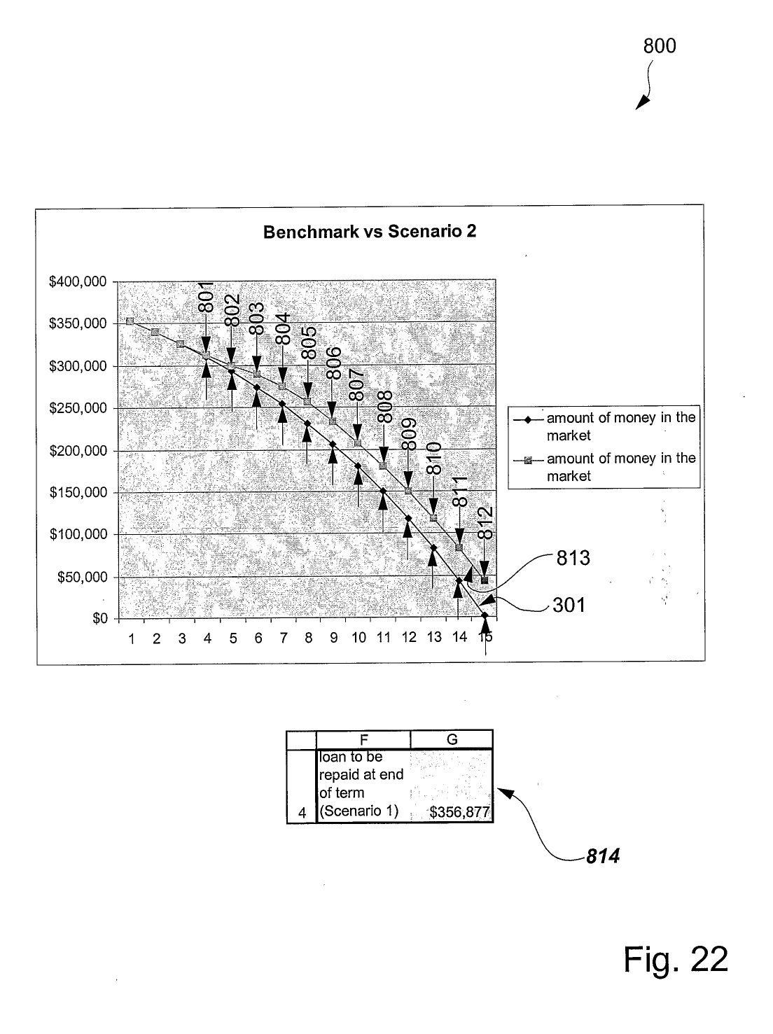

A benchmark curve 301 is depicted in FIG. 17. This benchmark curve 301 is also shown juxtaposed with two non-benchmark curves 613 and 813 in FIGS. 20 and 22 respectively. These non-benchmark curves are respectively referred to as the Scenario 1 curve and the Scenario 2 curve.

As noted in regard to the arrangement described in relation to FIG. 9, both the regular payment 213 to the retiree 201, and the amount of the loan repayment 217 can be “guaranteed”. In another arrangement (referred to as a “switching arrangement”), the payment 213 can be guaranteed, however the lack of performance of the investment vehicles 205 can be passed on to the retiree 201 in the form of an increased cost (referred to as a “performance deficit cost”) to be repaid at the end of the loan term. This performance deficit cost derives from additional loans and capitalized interest payments which are required to make up the performance deficit of the investment vehicles 205 during the term of the loan. The performance deficit cost is paid to the party providing the additional loans, and may be the financier 203 or the service provider 204 or another party (not shown). The term “switching arrangement” is used to indicate that when the performance of the investment vehicles 205 drops below a predetermined “market yield threshold”, the mode of operation of the arrangement switches from the method used in regard to FIG. 9 to a method in which the additional loans and capitalized interest payments are accrued.

FIG. 15 is a spreadsheet 100 showing the parameters used in a switching arrangement example. The value of the house 202 (see FIG. 9) is $1,000,000.00, and the maximum loan percentage which the financier 203 will lend is 40% of this value (see B3). The interest rate paid by the retiree 201 to the service provider 204 is 8.5% (B4) and the service charge, also depicted by 215 in FIG. 9 is 2% (at B5). The interest rate paid by the service provider 204 to the financier 203 at 216 is 5.5% (B6), and the term of the loan in question is 15 years (B7). The market yield threshold, this being the market-based rate of return which yields the benchmark curve previously referred to is 9.4% (B8).

The value of the maximum loan which is available based on the value of the house and the maximum loan proportion (B2 and B3 respectively) is $400,000.00 (E2). The gross annual payment from the service provider 204 to the retiree 201 at 213 is $26,666.67 (E3) which is determined by dividing the loan of $400,000.00 by the loan term of 15 years. The interest payment and administration fee paid by the retiree to the service provider at 215 are $2,266.67 and $533.33 respectively (E4 and E5 respectively). The total costs to the retiree per period are $2,800.00 (E6) as depicted by 215 in FIG. 9, and thus the net annual payment to the retiree at 213 is $23,866.67 (E7). The annual interest payment from the service provider 204 to the financier 203 at 216 is $22,000.00 (E8).

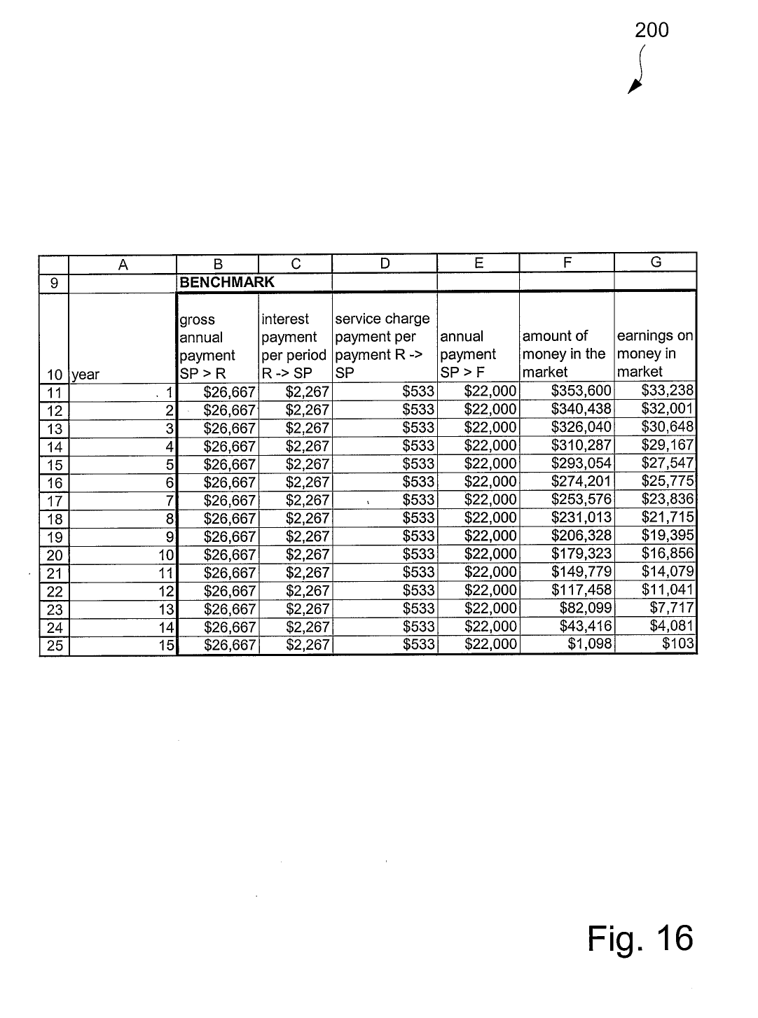

FIG. 16 shows a spreadsheet representation 200 of the various parameters referred to in regard to FIG. 15 over the 15 year term of the loan. The amount of money in the investment vehicles 205 is shown in column F, this commencing at $353,600.00 in the first year (ie., row 11) and reducing to approximately 0 (in fact being $1,098.00) in year 15.

FIG. 17 is a pictorial representation 300 of the parameters in FIG. 16. The amount of money in the investment vehicles 205 is depicted as the benchmark curve 301. Since the rate-of-return of the investment vehicles 205 is equal to the market yield threshold of 9.4% (B8 in FIG. 15), at the end of the loan term, the retiree 201 must repay 217 the loan which is equal to $400,000.00 (ie., 302 in FIG. 17), which is the original loan amount (E2) in FIG. 15.

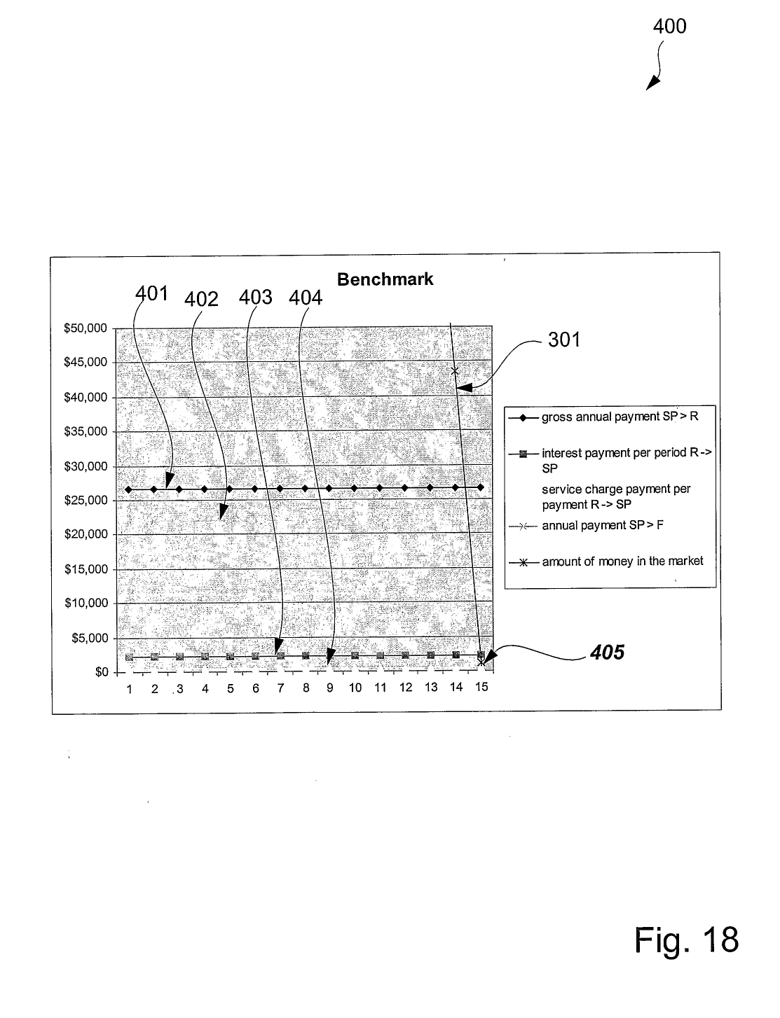

FIG. 18 is an expanded pictorial representation 400 of the representation in FIG. 17. The gross annual payment from the service provider 204 to the retiree 201 is $26,667 and is depicted at 401, while the annual payment 216 from the service provider 204 to the financier 203 is $22,000 and is depicted at 402. The interest payment per period paid by the retiree 201 to the service provider 204 is $2,267 and is depicted at 403, and the administration fee component is $533 and is shown at 404. The benchmark curve 301 is also shown in FIG. 18.

FIG. 19 shows a spreadsheet representation 500 of parameters establishing Scenario 1. This example differs from the benchmark example depicted in FIGS. 15 and 16 in that the market rate-of-return varies over time as shown in column H. The effect of this time varying market rate-of return is to change the amount of money in the investment vehicles 205 as depicted in column I. A column K in FIG. 19 depicts the variance between the amount of money in the investment vehicles 205 according to Scenario 1 and the amount of money in the investment vehicles 205 according to the benchmark example in column F of FIG. 16. Column K in FIG. 19 shows that there is no variance in years 1-3. There is a positive variance in years 4-9 (ie the investment vehicles 205 according to Scenario 1 have a higher rate-of-return that the investment vehicles 205 according to the benchmark parameters during this period). There is a negative variation in years 10-15 (ie the investment vehicles 205 according to Scenario 1 have a lower rate-of-return that the investment vehicles 205 according to the benchmark parameters during this period). Thus, a positive variance indicates that the market rate-of-return of the investments 205 exceeds the benchmark rate-of-return, whereas a negative variation means that the market rate-of-return is less than that of the benchmark.

FIG. 20 is a pictorial representation 600 of the benchmark curve 301 according to column F of FIG. 16 overlaid on the corresponding Scenario 1 curve 613 according to column I of FIG. 19. The Scenario 1 curve 613 exceeds the benchmark curve 301 for years 4-9, as depicted by reference numerals 601-606. The Scenario 1 curve 613 falls below the benchmark curve 301 for years 10-15, as depicted by reference numerals 607-612.

Returning to FIG. 19 and in particular to year 10 (see row 20), it is noted that the market rate-of-return variations shown in column H have resulted in the amount of money in the market 205 being $172,508.00 which is $6,814.00 less than the corresponding benchmark figure of $179,323.00 at F20 of FIG. 16. The impact of this negative variance is that the investment vehicles 205 are not returning sufficient earnings to meet the necessary payments, these being the regular payment 213 to the retiree, and the interest payment 216 to the financier 203. Accordingly, the disclosed switching arrangement “switches” from the mode of operation shown in the benchmark example to an arrangement in which an additional loan of $6,814.00 is raised at the 10 year point. This is depicted at L20 in FIG. 19. Furthermore, interest is charged on this additional loan of $6,814.00 for year 10 and for the remaining five years of the loan term. This interest is calculated according to the prevailing interest rates in column H from row 20 to row 25. Accordingly, the total interest which is capitalized for the additional loan of $6,814.00 is $1,635.00 as shown at M20.

In a similar manner, since the Scenario 1 curve 613 of FIG. 20 has a negative variance from the benchmark curve 301 for the remainder of the loan term, additional loans are required in each of the subsequent years 11-15. These are shown at L21-L25 in FIG. 19. Each of these additional loans incurs interest which is capitalized using the corresponding interest rates shown in column H, resulting in capitalized interest charges at M21-M25.

Returning to FIG. 20, the net result of the variance between the benchmark curve 301 and the Scenario 1 curve 613 is to add a “performance deficit cost” which the retiree 201 must repay 217 at the end of the loan term. The performance deficit cost is $180,994.00, this being made up by the total of the additional loans (L20-L25) in FIG. 19 plus the capitalized interest (M20-M25) in FIG. 19.

It is noted that the additional loan and the associated capitalized interest charges are only required in regard to negative variations depicted by 607-612 in FIG. 20. The positive variations depicted by 601-606 indicate that during the years 1-9 the investments 205 for the Scenario 1 curve 613 equal or exceed the performance of the benchmark curve 301, and accordingly no remedial action is required. In other words, during the years 1-9 the Scenario 1 example operates in the mode described in relation to FIG. 9. However, during the years 10-15 the Scenario 1 example switches operation mode to accumulate additional loans and capitalized interest as described.

FIG. 21 shows a spreadsheet depiction 700 referred to as Scenario 2 in which the market rate-of-return of the investments 205′ vary in a more favourable manner, as depicted in column N. The effect of the rates-of-return in column N of FIG. 21 is reflected in a corresponding curve 813 in FIG. 22 which is shown juxtaposed with the benchmark curve 301. The curve 813 exceeds the benchmark curve 301 from year 4-15, resulting in a residual amount of $43,123.00 remaining in the fund in the 15^{th} year (see O25 in FIG. 21). This positive residual amount (referred to as an excess performance benefit) reduces the amount of the repayment 217 required from the retiree 201 at the end of the loan term, resulting in a net repayment of $356,877.00 instead of the $400,000.00 originally borrowed.

As previously noted, and having regard, for example, to FIG. 9, in one arrangement, both the regular payment 213 to the retiree 201, and the amount of the loan repayment 217 can be “guaranteed” (by the service provider 204 or by another party). According to one example, the investment vehicle 205 can be structured as set out below. This investment vehicle can be used at least in 805 in FIG. 6, in 205 in FIG. 9, in 1205 in FIG. 12.

The investment vehicle 205, in this example, has three key elements, namely (a) it is capital guaranteed. This means that 100% of the issue price is underwritten by the service provider at expiry of the investment term, (b) a minimum income guarantee underwritten by the service provider, and (c) potential additional investment income (above a guaranteed minimum) is underwritten by the service provider. Decisions made by the service provider in this context are decisions made by the service provider acting for or on behalf of the retiree and/or the baby-boomer.

The investment vehicle works by creating or contributing to an investment fund managed by the service provider which comprises particular asset classes which, in combination, ensure that two objectives are met, namely: (a) the 3 key elements of the investment vehicle described above and (b) maintaining of sufficient liquidity to met payments by the service provider from the investment fund to or on behalf of the retiree/baby boomer as and when they fall due.

Typically, these objectives require the investment fund to include a mix of liquid, semi-liquid and fixed or defined term investments in the following asset classes:

1. cash

2. bank bills

3. government bonds

4. equities (which may be capital guaranteed)

5. defined outcome investment products (which are capital guaranteed).

The precise mix of these assets classes will change over the term of the investment and according to interest rate and investment market conditions. The investment weighting between asset classes is determined by a financial or actuarial analysis of the cash-flow requirements of the service provider by reference to the amount and timing of each payment and receipt out of and into the investment fund including, payments of loan interest to the lender, repayments of loan principal to the retiree/baby-boomer and other charges and fees and receipts of simple interest and administration fees from the retiree/baby-boomer.

The use of asset classes (i) to (iv) in combination with one or more capital guaranteed investment products provides very useful outcomes.

At any time during the loan term, the greatest proportion of investment funds will be held in asset class (v), namely one or more capital guaranteed defined outcome investment products. This is so because asset classes (i) to (iv) are intended to provide liquidity rather than high yielding investment returns or capital growth.

Asset class (v) however, is designed to provide higher yielding investment returns with the security of a capital guarantee and a minimum income guarantee. When used in combination with other asset classes described above, the investment fund so created has the features necessary to achieve the objectives of the investment vehicle. The general principles of how the capital guaranteed defined outcome investment product (being asset class (v)) works, in this example, is as follows. The monies invested (eg in 805 in FIG. 6) are split between two asset types, namely (a) Zero coupon bonds, and (b) Options. The capital guarantee is achieved by investing a significant portion of the invested monies in zero coupon bonds (i.e. a bond which does not provide a regular income payment). Typically, on a 6 year zero coupon bond with a yield of, say, 5.5% pa, around 70% of the invested monies will be required to be placed in this asset type in order to secure 100% capital guarantee.

Income returns are achieved by placing balance of around 30% in direct investment in the securities forming the reference portfolio and option strategies. The minimum income guarantee is achieved as follows. The purpose of setting a maximum coupon rate is to achieve stability, reduce volatility and to maximise returns while minimising risk. This is done by supporting the options with a “call overwriting” strategy through the use of call options against a portfolio of shares, whereby the service provider is paid to agree to sell their securities at a certain price. In exchange for being paid, the service provider gives up any increase in the value of the security above the strike price. In other words, the service provider limits some upside potential in return for some downside protection. Because the invested monies are capital guaranteed, there is no need for a separate put option.

In particular, specific features of the aforementioned asset class, in this example, are:
Fixed entry or subscription point
Minimum subscription amount (typically $5,000)
Fixed investment term (typically 5-7 years)
It has coupons linked to the performance of a selected investment reference portfolio of securities (typically 30-50 selected stocks)
The reference portfolio of securities are historically high yielding National and/or International blue chip securities
Service provider choice of National or Global securities in the Reference Portfolio
Pays a minimum annual coupon which is guaranteed (typically 3-4% of the issue price per annum)
Pays an additional increased annual coupon (i.e. above the minimum coupon rate) based on annual portfolio performance above the average from which the minimum coupon rate has been set
The amount by which the Coupon can be increased is capped.
Performance above the capped amount represents investment profit and incentive to the service provider.
Each security in the reference portfolio is subject to a maximum percentage increase each quarter which is used to calculate the maximum coupon rate
The maximum percentage increase (i.e. the cap) is calculated by reference to the local currency swap rate which coincides with the investment term (typically 10%-30% depending upon the swap rate)
Downside protection feature permits early termination by the service provider subject to capital guarantee (i.e. 100% of the issue price) when, on any anniversary, all the securities in the reference portfolio falls by 15% or more from their initial price at the issue date
The service provider derives income from the Coupons which are calculated by reference to the quarterly performance of the reference portfolio subject to the cap of maximum income level set
Individual securities forming the Reference Portfolio can be re-selected annually on each anniversary date to eliminate non-performing stocks and/or re-balance the portfolio
Selection criteria for the Reference Portfolio are:
   100 largest stocks in recognised National (and/or Global) indices
   Average turnover greater than $10 million for National securities ($20 million for international securities) per day
   Top 30 securities based upon highest historical cash dividend yield
   Maximum weighting of 20% for any industry sector in the Reference Portfolio

### INDUSTRIAL APPLICABILITY

It is apparent from the above that the arrangements described are applicable to the financial investment and planning industries.

The foregoing describes only some embodiments of the present invention, and modifications and/or changes can be made thereto without departing from the scope and spirit of the invention, the embodiments being illustrative and not restrictive. Thus, in some arrangements, the disclosed arrangements can usually qualify as a Life Expectancy income stream retirement product under Social Security Rules, thus being eligible for inclusion in long term assets test exempt category. The disclosed life expectancy retirement annuity arrangement may thus be arranged to be “complying” under the Social Security Rules, and thus be exempt from asset tests (and, in some cases income tax). The disclosed financial product can also be arranged to be non-commutable but reversionary, so that in the event of the retirees death, 100% of the payments continue for the loan term to be payable to the spouse or de-facto spouse or beneficiary named in a Will. Other benefits can be bundled with the disclosed life expectancy retirement annuity financial product. Free or low cost accident insurance can be offered to the retiree as part of the package, with the service provider absorbing some or all costs of such cover. The service provider can arrange for self-insurance to ensure that the repayment of the loan to the financier at the end of the loan is ensured against unforeseen significant falls in the property market.

### APPENDIX A

Formula Representations of Spreadsheets in FIGS. 2, 4, 8, 11, 13, 15, 16, 19, and 21

[image]

[image]

[image]

[image]

[image]

[image]

[image]

[image]

[image]

[image]

[image]

[image]

1. A computer-based system for providing equity based benefits to a person dependent upon equity in property owned by the person, said system comprising:
a memory for storing a program; and
a processor for executing the program, said program comprising:
(a) code for securing a loan secured by a proportion of the equity, the loan having a principal value for a defined term;
(b) code for repaying the loan by periodically paying a simple an interest charge determined on a simple interest basis;
(c) code for investing a residual of the loan;
(d) code for, if an equity-based retirement savings option is elected, accumulating earnings from the invested residual of the loan; and
(e) code for, if a life-expectancy retirement annuity option is elected, making a periodic payment from the residual of the loan; wherein the principal value of the loan becomes due for repayment at the end of the term.

2. A system according to claim 1, wherein:
the memory is configured as a plurality of memory modules;
the program is configured as a plurality of inter-related program modules stored in corresponding said memory modules; and
the processor is configured as a plurality of processor modules for executing the program modules, wherein at least some of the plurality of processor modules adapted to communicate over a network.

3. A system according to claim 1, wherein if a rate of return of an investment in which said residual of the loan is invested according to the code (c) falls below a threshold, the program further comprises:
(f) code for capitalizing an additional loan amount needed to compensate for a difference between the rate of return and the threshold; and
(g) code for adding said additional loan to the principal of the loan to be repaid at the end of the term.

4. A computer program product including a computer readable medium having recorded thereon a computer program for directing a processor to execute a method for providing equity based benefits to a person dependent upon equity in property owned by the person, said program comprising:
(a) code for securing a loan secured by a proportion of the equity, the loan having a principal value for a defined term;
(b) code for repaying the loan by periodically paying an interest charge determined on a simple interest basis;
(c) code for investing a residual of the loan;
(d) code for, if an equity-based retirement savings option is elected, accumulating earnings from the invested residual of the loan; and
(e) code for, if a life-expectancy retirement annuity option is elected, making a periodic payment from the residual of the loan; wherein the principal value of the loan becomes due for repayment at the end of the term.

5. A computer-based system for providing equity based benefits to a person dependent upon equity in property owned by the person, said system comprising:
(a) means for securing a loan secured by a proportion of the equity, the loan having a principal value for a defined term;
(b) means for repaying the loan by periodically paying an interest charge determined on a simple interest basis;
(c) means for investing a residual of the loan;
(d) means for, if an equity-based retirement savings option is elected, accumulating earnings from the invested residual of the loan; and
(e) means for, if a life-expectancy retirement annuity option is elected, making a periodic payment from the residual of the loan; wherein the principal value of the loan becomes due for repayment at the end of the term.

6. A method for providing equity based benefits to a person dependent upon equity in property owned by the person, said method being implemented on a computer based system comprising at least one program running on a corresponding at least one computer platform, said method comprising the steps of:
securing a loan secured by a proportion of the equity, the loan having a principal value for a defined term;
repaying the loan by periodically paying an interest charge determined on a simple interest basis;
investing a residual of the loan;
if an equity-based retirement savings option is elected, accumulating earnings from the invested residual of the loan; and
if a life-expectancy retirement annuity option is elected, making a periodic payment from the residual of the loan; wherein the principal value of the loan becomes due for repayment at the end of the term.

7. A method of generating, for a person, periodic payments secured by equity in property of the person, the method comprising the steps of:
(a) obtaining, from a first provider, a loan having a principal value for a defined term, wherein the loan is secured by the equity;
(b) repaying the loan by periodically paying, to the first provider over the term, an interest payment determined on a simple interest basis;
(c) paying, to the person, the periodic payments;
(d) charging the person, in regard to each said periodic payment, a charge determined on a simple interest basis;
(e) investing a residual of the loan, in an investment vehicle yielding a return at a compound rate on said residual of the loan, said residual of the loan being dependent upon the amounts paid in the steps (b) and (c) and the amount received in the step (d); and
(f) repaying, to the first provider at the end of the term, the principal of the loan.

8. A method according to claim 7, wherein the residual of the loan invested in the investment vehicle at any time during the term of the loan is equal to the principal of the loan less (i) the accumulated payments made in the steps (b) and (c) from the time the loan was obtained until said any time being considered, plus (ii) the accumulated charges received in the step (d) from the time the loan was obtained until said any time being considered.

9. A method according to claim 7, wherein the steps (a)-(e) are performed by a second provider and the step (e) is performed by the person.

10. A method according to claim 9, wherein the amounts paid in the steps (b) and (c) are drawn from the residual of the loan and the amount received in the step (d) is paid into the residual of the loan.

11. A method according to claim 9, wherein:
the loan is less than or equal to 45% of the equity in the property of the person;
the first fixed proportion is in a range of 4.0% and 5.5%;
the second fixed proportion is in a range of 7.5% and 12.0%; and
the compound rate of return is in a range of 7.5% and 12.0% of the residual of the loan that is invested in the investment vehicle.

12. A method according to claim 9, comprising the further step of:
(g) charging the person, in regard to each said periodic payment, a charge equal to a third fixed proportion of said each said periodic payment;

13. A method according to claim 12, wherein the third fixed proportion is in a range of 0.05% and 0.25%.

14. A method according to claim 12 wherein the profit derived by the second provider comprises the charge levied in the step (g).

15. A method according to claim 9 wherein the profit derived by the second provider is drawn from the residual of the loan.

16. A method according to claim 7, wherein the person is one of a natural person and a legal entity.

17. A method according to claim 7, wherein the person is a retiree and the property of the retiree is the home of the retiree.

18. A method of generating, for a retiree, periodic payments secured by equity in the retiree's home, the method comprising the steps of:
(a) obtaining, from a financier, a loan having a principal value for a defined term, wherein the loan is secured by the equity in the retiree's home;
(b) repaying the loan by periodically paying, to the financier over the term, an interest repayment determined on a simple interest basis;
(c) paying, to the retiree, the periodic payments;
(d) charging the retiree, in regard to each said periodic payment, a simple an interest charge determined on a simple interest basis;
(e) investing a residual of the loan, in an investment vehicle yielding a return at a compound rate on said residual of the loan, said residual of the loan being dependent upon the simple interest payments to the financier in the step (b) and the periodic payments to the retiree in the step (c) and the simple interest charges paid by the retiree in the step (d); and
(f) repaying, by the retiree to the financier at the end of the term, the principal of the loan.

19. A method of generating, for a retiree, periodic payments secured by equity in the retiree's home, the method comprising the steps of:
(a) obtaining, by a service provider from a financier, a loan having a principal value for a defined term, wherein the loan is secured by the equity in the retiree's home;
(b) repaying the loan by periodically paying, by the service provider to the financier over the term, an interest repayment determined on a simple interest basis;
(c) paying, by the service provider to the retiree, the periodic payments;
(d) charging the retiree by the service provider, in regard to each said periodic payment, an interest charge determined on a simple interest basis;
(e) the service provider investing a residual of the loan, in an investment vehicle yielding a return at a compound rate on said residual of the loan, said residual of the loan being dependent upon the simple interest payments to the financier in the step (b) and the periodic payments to the retiree in the step (c) and the simple interest charges paid by the retiree in the step (d); and
(f) repaying, by the retiree to the financier at the end of the term, the principal of the loan.

20. A system for generating, for a retiree, periodic payments secured by equity in the retiree's home, the system comprising:
(a) means for obtaining, by a service provider from a financier, a loan having a principal value for a defined term, wherein the loan is secured by the equity in the retiree's home;
(b) means for repaying the loan by periodically paying, by the service provider to the financier over the term, an interest repayment determined on a simple interest basis;
(c) means for paying, by the service provider to the retiree, the periodic payments;
(d) means for charging the retiree by the service provider, in regard to each said periodic payment, an interest charge determined on a simple interest basis;
(e) means by which the service provider invests a residual of the loan, in an investment vehicle yielding a return at a compound rate on said residual of the loan, said residual of the loan being dependent upon the simple interest payments to the financier in the step (b) and the periodic payments to the retiree in the step (c) and the simple interest charges paid by the retiree in the step (d); and
(f) means for repaying, by the retiree to the financier at the end of the term, the principal of the loan.

21. A computer program product having a computer readable medium having at least one computer program module recorded therein for directing at least one processor to implement a method of generating, for a retiree, periodic payments secured by equity in the retirees home, the at least one program module comprising:
(a) code for obtaining, by a service provider from a financier, a loan having a principal value for a defined term, wherein the loan is secured by the equity in the retiree's home;
(b) code for periodically paying, by the service provider to the financier over the term, an interest repayment determined on a simple interest basis;
(c) code for paying, by the service provider to the retiree, the periodic payments;
(d) code for charging the retiree by the service provider, in regard to each said periodic payment, an interest charge determined on a simple interest basis;
(e) code for investing a residual of the loan, in an investment vehicle yielding a return at a compound rate on said residual of the loan, said residual of the loan being dependent upon the simple interest payments to the financier in the step (b) and the periodic payments to the retiree in the step (c) and the simple interest charges paid by the retiree in the step (d); and
(f) code for repaying, by the retiree to the financier at the end of the term, the principal of the loan.

22. A method of generating, for the benefit of a person and a service provider, periodic payments dependent upon equity in property of the person, the method comprising the steps of:
(a) obtaining from a financier a loan secured by the equity, the loan having a principal value and being for a term defined by a number of periods;
(b) investing the loan in a first investment vehicle that yields a first return for each said period on the amount invested; the method further comprising, for a current said period, the steps of:
(i) determining, in regard to the principal value, a first amount determined on a simple interest basis, and withdrawing said first amount from the residual of the loan invested in the first investment vehicle, and determining, in regard to the principal value, a second amount determined on a simple interest basis, and withdrawing said second amount from the residual of the loan invested in the first investment vehicle;
(ii) paying the first amount to the financier;
(iii) deducting a charge from said second amount, said charge comprising the benefit for the service provider;
(iv) investing for the benefit of the person the residual of the second amount in an investment vehicle yielding a second return for the current period, said second return being lower than the first return;
(c) repeating the steps (i)-(iv) for said number of periods; and
(d) repaying, by the person to the financier at the end of the term, the principal of the loan.

23. A method according to claim 22, wherein the financier is the service provider.

24. A method according to claim 22, wherein in the step (iv) an additional investment is made in the investment vehicle yielding the second return for the current period.

25. A method according to claim 24, wherein the additional investment is a savings contribution by the person.

26. A method according to claim 25, wherein following the step (d) the method comprises further steps of:
(a) obtaining from the financier another loan secured by equity in the persons home, the other loan having a principal value and being for a term defined by a number of periods;
(b) investing the other loan and the funds accumulated in the investment vehicle yielding the second return in another investment vehicle that yields a return for each said period on the amount invested; the method further comprising, for a current said period, the steps of:
(i) determining, in regard to the principal value, a third amount determined on a simple interest basis, and withdrawing said third amount from the residual of the loan invested in the first investment vehicle, and determining in regard to the principal value a fourth amount determined on a simple interest basis. and withdrawing said fourth amount from the residual of the loan invested in the first investment vehicle;
(ii) paying the third amount to the financier;
(iii) deducting a charge from said fourth amount, said charge comprising the benefit for the service provider;
(iv) paying the residual of the second fixed proportion to the person;
(c) repeating the steps (i)-(iv) for said number of periods; and
(d) repaying, by the person to the financier at the end of the term, the principal of the loan.

27. A computer based method of generating, for a person, periodic payments secured by equity in property of the person, the method comprising the steps of:
(a) obtaining, from a first provider, a loan having a principal value for a defined term, wherein the loan is secured by the equity;
(b) periodically paying, to the first provider over the term, an interest payment determined on a simple interest basis;
(c) paying, to the person, the periodic payments;
(d) charging the person, in regard to each said periodic payment, an interest charge determined on a simple interest basis;
(e) investing a residual of the loan, in an investment vehicle yielding a return at a compound rate on said residual of the loan, said residual of the loan being dependent upon the amounts paid in the steps (b) and (c) and the amount received in the step (d); and
(f) repaying, to the first provider at the end of the term, the principal of the loan; wherein:
(g) if the compound rate in the step (e) falls below a first threshold, an additional loan amount needed to compensate for the reduced compound rate, and associated interest, is capitalized and added to the principal of the loan to be repaid to the first provider in the step (f).

28. A computer based method according to claim 27, comprising the further step of:
(h) if the compound rate in the step (e) rises above a second threshold, then accumulated surplus funds accruing in the investment vehicle are deducted from the principal of the loan to be repaid to the first provider in the step (f).

29. A system for administering an equity based arrangement of generating, for a person, periodic payments secured by equity in property of the person, the system comprising:
(a) means for obtaining, from a first provider, a loan having a principal value for a defined term, wherein the loan is secured by the equity;
(b) means for periodically paying, to the first provider over the term, an interest payment determined on a simple interest basis;
(c) means for paying, to the person, the periodic payments;
(d) means for charging the person, in regard to each said periodic payment, an interest charge determined on a simple interest basis;
(e) means for investing a residual of the loan, in an investment vehicle yielding a return at a compound rate on said residual of the loan, said residual of the loan being dependent upon the amounts paid in the steps (b) and (c) and the amount received in the step (d); and
(f) means for repaying, to the first provider at the end of the term, the principal of the loan; wherein:
(g) if the compound rate in the step (e) falls below a first threshold, an additional loan amount needed to compensate for the reduced compound rate, and associated interest, is capitalized and added to the principal of the loan to be repaid to the first provider in the step (f).

30. A system for administering an equity based arrangement of generating, for a person, periodic payments secured by equity in property of the person, the system comprising:
a plurality of memory modules for storing a corresponding plurality of inter-related application program modules; and
a plurality of processor modules for executing the program modules, said program modules comprising:
(a) code for obtaining, from a first provider, a loan having a principal value for a defined term, wherein the loan is secured by the equity;
(b) code for periodically paying, to the first provider over the term, an interest payment determined on a simple interest basis;
(c) code for paying, to the person, the periodic payments;
(d) code for charging the person, in regard to each said periodic payment, an interest charge determined on a simple interest basis;
(e) code for investing a residual of the loan, in an investment vehicle yielding a return at a compound rate on said residual of the loan, said residual of the loan being dependent upon the amounts paid in the steps (b) and (c) and the amount received in the step (d); and
(f) code for repaying, to the first provider at the end of the term, the principal of the loan; wherein:
(g) if the compound rate in the step (e) falls below a first threshold, an additional loan amount needed to compensate for the reduced compound rate, and associated interest, is capitalized and added to the principal of the loan to be repaid to the first provider in the step (f).

31. A computer program product including at least one computer readable medium having recorded thereon a plurality of inter-related computer application program modules for directing a plurality of processor modules to execute a method for generating, for a person, periodic payments secured by equity in property of the person, said program modules comprising:
(a) code for obtaining, from a first provider, a loan having a principal value for a defined term, wherein the loan is secured by the equity;
(b) code for periodically paying, to the first provider over the term, an interest payment determined on a simple interest basis;
(c) code for paying, to the person, the periodic payments;
(d) code for charging the person, in regard to each said periodic payment, an interest charge determined on a simple interest basis;
(e) code for investing a residual of the loan, in an investment vehicle yielding a return at a compound rate on said residual of the loan, said residual of the loan being dependent upon the amounts paid in the steps (b) and (c) and the amount received in the step (d); and
(f) code for repaying, to the first provider at the end of the term, the principal of the loan; wherein:
(g) if the compound rate in the step (e) falls below a first threshold, an additional loan amount needed to compensate for the reduced compound rate, and associated interest, is capitalized and added to the principal of the loan to be repaid to the first provider in the step (f).

32. A plurality of inter-related computer application program modules for directing a plurality of processor modules to execute a method for generating, for a person, periodic payments secured by equity in property of the person, said program modules comprising:
(a) code for obtaining, from a first provider, a loan having a principal value for a defined term, wherein the loan is secured by the equity;
(b) code for periodically paying, to the first provider over the term, an interest payment determined on a simple interest basis;
(c) code for paying, to the person, the periodic payments;
(d) code for charging the person, in regard to each said periodic payment, an interest charge determined on a simple interest basis;
(e) code for investing a residual of the loan, in an investment vehicle yielding a return at a compound rate on said residual of the loan, said residual of the loan being dependent upon the amounts paid in the steps (b) and (c) and the amount received in the step (d); and
(f) code for repaying, to the first provider at the end of the term, the principal of the loan; wherein:
(g) if the compound rate in the step (e) falls below a first threshold, an additional loan amount needed to compensate for the reduced compound rate, and associated interest, is capitalized and added to the principal of the loan to be repaid to the first provider in the step (f).

33. (canceled)

34. (canceled)

35. A method of generating, for the benefit of a person and a service provider, periodic payments dependent upon equity in property of the person, said method being implemented on a computer based system comprising at least one program running on a corresponding at least one computer platform, the method comprising the steps of:
(a) obtaining from a financier a loan secured by the equity, the loan having a principal value and being for a term defined by a number of periods.
(b) investing the loan in a first investment vehicle that yields a first return for each said period on the amount invested; the method further comprising, for a current said period, the steps of:
(i) withdrawing an interest charge, determined on a simple interest basis with reference to the principal value, and further withdrawing a fixed proportion of the principal value, from the residual of the loan invested in the first investment vehicle;
(ii) paving the interest charge to the financier;
(iii) deducting a charge from said fixed proportion, said charge comprising the benefit for the service provider;
(iv) investing for the benefit of the person the residual of the fixed proportion in an investment vehicle yielding a second return for the current period, said second return being lower than the first return;
(c) repeating the steps (i)-(iv) for said number of periods; and
(d) repaying, by the person to the financier at the end of the term the principal of the loan.
